(19) United States
(12) Patent Application Publication
(10) Pub. No.: US 2015/0342377 A1
(43) Pub. Date: Dec. 3, 2015

(54) Pillow for displaying imagery and playing associated audio

(71) Applicant: Gregory L. Hall, Mayfield Village, OH (US)

(72) Inventor: Gregory L. Hall, Mayfield Village, OH (US)

(21) Appl. No.: 14/120,539

(22) Filed: May 30, 2014

(51) Int. Cl. A47G 9/10; H04R 3/00; G09G 5/12; A47G 1/06; G09G 5/00

(52) U.S. Cl. CPC A47G 9/1045; A47G 1/0638; G09G 5/003; G09G 5/12; H04R 3/00; G09G 2380/00; G09G 2354/00; G09G 2320/10; G09G 2320/08

(57) ABSTRACT

A patient comfort pillow has an outer surface that carries an image that is meaningful to a patient, and has an interior space carrying an acoustic driver that acoustically outputs an audio recording associated with the image and to which the patient can listen in response to physical handling directed at the image by the patient. The patient comfort pillow may include a pouch made of transparent material on the outer surface to hold a photograph bearing the image for viewing through the transparent material. Alternatively, the image may be printed on or sewn into the outer surface. The patient comfort pillow may include a microphone carried within the interior space to record the audio recording. Other enhancements are disclosed, such as an antenna to wirelessly receive the audio recording from another device.

### BACKGROUND

The present invention relates to patient comfort pillows that visually present imagery of persons, places, objects or experiences of significance to patients in medical facilities, and that acoustically output audio recordings associated with the imagery to those patients in response to physical handling by those patients. More particularly, the present invention relates to patient comfort pillows able to visually present an image on an outer surface thereof, able to detect physical handling thereof by a person (e.g., squeezing or other physical handling by a patient) to whom the image has a meaning, and able to acoustically output at least one audio recording associated with the image in response to the physical handling.

As is familiar to anyone who has needed to stay within a medical facility away from familiar surroundings and persons, especially for an extended period of time, the experience may be both physically and emotionally unsettling. The combination of unfamiliar sights, sounds, smells, food and/or scheduling of medical care and/or other activities can bring about a longing for something more familiar to bring a modicum of emotional comfort. This may include a desire for interaction with family members and/or friends who, unfortunately, may not be available due to ill health, death, distance or necessary visitation restrictions.

It has long been known that tolerance of medical procedures, recovery from illness and other aspects of well being are generally enhanced by providing patients with more of what is familiar to them, rather than less. In lieu of being allowed to stay at their homes, instead of a medical facility, the sight of a familiar place, object, or face of a family member or friend can be very helpful in providing emotional comfort, as well as the sounds of a place or the voice of a family member or friend.

A time-honored approach to providing such comfort has been the provision of photographs of beloved places and/or persons, either mounted on a wall or set in frames on a table or other furnishings. However, photographs provide little interaction beyond their ability to be seen, and may be entirely ineffective at providing emotional comfort to patients who are visually impaired or who are otherwise unable to view them. A further difficulty in the use of photographs to provide emotional comfort is that elderly patients with physical impairments in using their hands may desire to touch or hold the photographs, and in so doing, may be prone to dropping or otherwise clumsily handling them. The resulting damage to framed photographs may then only add to the emotional upset of the patient.

An additional difficulty arises in efforts made by some well-meaning persons to provide electronic devices meant to display images to elderly patients in a manner akin to framed photographs. Not unlike framed photographs, such electronic devices may very easily and quickly be damaged by being dropped or otherwise clumsily, handled by physically impaired elderly patients. Further, elderly patients tend to be less comfortable than younger individuals with operating complex electronic devices (e.g., smartphones, tablet computers, and the like). Also, elderly patients may suffer from various forms of dementia that impair their ability to learn how to operate electronic devices, even if they would otherwise be eager to learn.

### SUMMARY

The present invention addresses such needs and deficiencies as are mentioned above by providing, a patient comfort pillow capable of visually presenting at least one image on an outer surface thereof, detecting physical handling thereof by a patient, and acoustically outputting recorded audio associated with an object, place and/or person depicted in the image. The patient comfort pillow may be part of an patient comfort system in which an interaction device of the patient comfort pillow is in contact with one or more other devices to receive updated and/or additional audio recordings, and/or to receive commands controlling the acoustic output of audio recordings.

The image may be visually presented with a photograph carried in a pouch on an outer surface of the patient comfort pillow, with printing on the outer surface and/or with an electronic display incorporated into the outer surface. The audio recording selected for acoustic output may be so selected in response to such things as a patient-selected portion of the pillow that is handled by the patient, the image that is visually presented by the patient-selected portion, the day of the week, the hour of the day and/or the date. The image that is visually presented and/or the audio recording that is selected for acoustic output may be associated with a deceased person known to the patient. The audio recording may be of the voice of that deceased person.

In one form of preferred practice of the invention, a patient comfort pillow has an outer surface that carries an image that is meaningful to a patient, and has an interior space carrying an acoustic driver that acoustically outputs an audio recording associated with the image and to which the patient can listen in response to physical handling directed at the image by the patient. The patient comfort pillow may include a pouch made of transparent material on the outer surface to hold a photograph bearing the image for viewing through the transparent material. Alternatively, the image may be printed on or sewn into the outer surface. The patient comfort pillow may include a microphone carried within the interior space to record the audio recording. Alternatively or additionally, the patient comfort pillow may include an antenna to wirelessly receive the audio recording from another device.

In another form of preferred practice, an apparatus includes a pillow portion defining an outer surface to visually present an image and including a cushion portion shaped to define an interior space of the pillow portion surrounded by soft material. The apparatus further includes an interaction device for insertion into the interior space, wherein the interaction device includes an acoustic driver, and a control circuit to monitor a first sensor for an indication of detection by the first sensor of a selected type of physical handling of the pillow portion and to operate the acoustic driver to acoustically output an audio recording associated with the image based on the indication of detection.

In still another form of preferred practice, a computer-implemented method includes visually presenting an image on an outer surface of a pillow portion of a patient comfort pillow comprising the pillow portion and an interaction device, wherein the pillow portion defines an interior space in which the interaction device is, carried and is substantially surrounded by soft material of a cushion portion of the pillow portion. The computer-implemented method further includes monitoring a first sensor of the patient comfort pillow for an indication of detection by the first sensor of a selected type of physical handling of the pillow portion, and operating an acoustic driver of the interaction device to acoustically output an audio recording associated with the image based on the indication of detection.

In yet another form of preferred practice, a non-transitory machine-readable storage medium includes instructions that when executed by a processor component, cause the processor component to operate a display of a patient comfort pillow to visually presenting an image, wherein the pillow portion defines an interior space in which an interaction device of the patient comfort pillow is carried and is substantially surrounded by soft material of a cushion portion of the pillow portion, and wherein the interaction device comprises the processor component. The processor component is further caused to monitor a first sensor of the patient comfort pillow for an indication of detection by the first sensor of a selected type of physical handling of the pillow portion; select the audio recording based at least partly on an association of the audio recording to the image currently visually presented on the display; and operate an acoustic driver of the interaction device to acoustically output the audio recording associated with the image based on the indication of detection.

### BRIEF DESCRIPTION OF THE DRAWINGS

A fuller understanding of what is disclosed in the present application may be had by referring to the description and claims that follow, taken in conjunction with the accompanying drawings, wherein:

FIG. 1 is an exploded perspective view of an example embodiment of a patient comfort pillow that includes a pillow case carrying a pouch into which a photograph may be inserted to present an image, a cushion portion shaped for insertion into the pillow case and to define an interior space, and an interaction device to be carried within the interior space of the cushion portion and to acoustically output an audio recording in response to detecting physical handling of a portion of the patient comfort pillow by a patient.

FIG. 2 is a block diagram of an example embodiment of components of at least the interaction device of the patient comfort pillow of FIG. 1 that cooperate to enable recording of the audio recording, to detect the physical handling, and to acoustically output the audio recording in response to detecting the physical handling.

FIG. 3 is an exploded perspective view of an example embodiment of the photograph of the patient comfort pillow of FIG. 1 that wirelessly transmits at least an identifier to the interaction device.

FIG. 4 is an exploded perspective view of an alternate example embodiment of the photograph of the patient comfort pillow of FIG. 1 that wireless transmits an identifier and an indication of what portion of the image of the photograph at which the physical handling is directed to the interaction device.

FIG. 5 is an exploded perspective view, similar to FIG. 1, of an alternate example embodiment of a patient comfort pillow in which the pillow case carries two pouches into which photographs may be inserted to present two images, and in which the interaction device employs separately positionable sensors to separately detect physical handling directed at one or other of the two images.

FIG. 6 is a block diagram of an example embodiment of components of at least the interaction device of the patient comfort pillow of FIG. 5 that cooperate to separately detect physical handling directed at one or the other of the two images, and to select an audio recording to acoustically output based on which of the two images the physical handling is directed at.

FIG. 7 is an exploded perspective view of an example embodiment of a patient comfort system that includes a patient comfort pillow carrying a pouch into which a photograph may be inserted to present an image, a cushion portion shaped to define an interior space, an interaction device to be carried within the interior space of the cushion portion and to acoustically output an audio recording in response to detecting physical handling, a content device to provide the audio recording to the interaction device, and a control device to selectively enable and disable the acoustic output of the audio recording.

FIG. 8 is a block diagram of an example embodiment of components of the interaction device, the content device and the control, device of the patient comfort pillow of FIG. 7 that cooperate to enable recording of the audio recording, to detect the physical handling, to acoustically output the audio recording in response to detecting the physical handling, and to selectively enable and disable the acoustic output of the audio recording.

FIG. 9 is an exploded perspective view, similar to FIG. 7, of an alternate example embodiment of a patient comfort system in which the pillow case is of a different shape and directly presents an image.

FIG. 10 is a block diagram of an example embodiment of components of the interaction device, the content device and the control device of the patient comfort pillow of FIG. 9 that cooperate to enable recording of the audio recording, to detect physical handling, to acoustically output the audio recording in response to detecting the physical handling, and to selectively enable and disable the acoustic output of the audio recording.

FIG. 11 is an exploded perspective view of an example embodiment of attachment of a tag device that wirelessly transmits at least an identifier to the interaction device of FIG. 9 to a portion of the pillow case of FIG. 9.

FIG. 12 is an exploded perspective view, similar to FIG. 9, of another alternate example embodiment of a patient comfort system in which the pillow case presents two images, and in which the interaction device employs separately positionable sensors to separately detect physical handling directed at one or other of the two images.

FIG. 13 is a block diagram of an example embodiment of components of the interaction device, the content device and the control device of the patient comfort pillow of FIG. 12 that cooperate to separately detect physical handling directed at one or the other of the two images, and to select an audio recording to acoustically output based on which of the two images the physical handling is directed at.

FIG. 14 is an exploded perspective view, similar to FIG. 9, of still another alternate example embodiment of a patient comfort system in which the patient comfort pillow incorporates a display to presents a dynamically changeable image, and in which the interaction device selects an audio recording to acoustically output based on the image that is currently presented on the display.

FIG. 15 is a block diagram of an example embodiment of components of the interaction device, the content device and the control device of the patient comfort pillow of FIG. 14 that cooperate to visually present different images on the display, to select an audio recording to acoustically output based on the image currently presented on the display, and to acoustically output the selected audio recording in response to physical handling directed at the image currently presented on the display.

FIG. 16 is a block diagram of an example processing architecture that may be employed by any of the embodiments of FIG. 2, 6, 8, 10, 13 or 15.

FIG. 17 is a block diagram of an example processing architecture that may be employed by any of the embodiments of FIG. 8, 10, 13 or 15.

FIG. 18 is a flow chart of logic implemented by an example embodiment of an interaction device of a patient comfort pillow to record an audio recording in response to operation of manually operable controls and/or to acoustically output the audio recording in response to physical handling of the patient comfort pillow.

FIG. 19 is a flow chart of logic implemented by another example embodiment of an interaction device of a patient comfort pillow to select and acoustically output an audio recording in response to physical handling of the patient comfort pillow.

FIG. 20 is a flow chart of logic implemented by still another example embodiment of an interaction device of a patient comfort pillow to select an audio recording for acoustic output based on an identifier and/or indication of detected physical handling from one or more tag devices.

FIG. 21 is a flow chart of logic implemented by yet another example embodiment, of an interaction device of a patient comfort pillow to visually present still images on a display and to select an audio recording for acoustic output based on an association of the audio recoding with the still image currently visually presented on the display.

### DETAILED DESCRIPTION

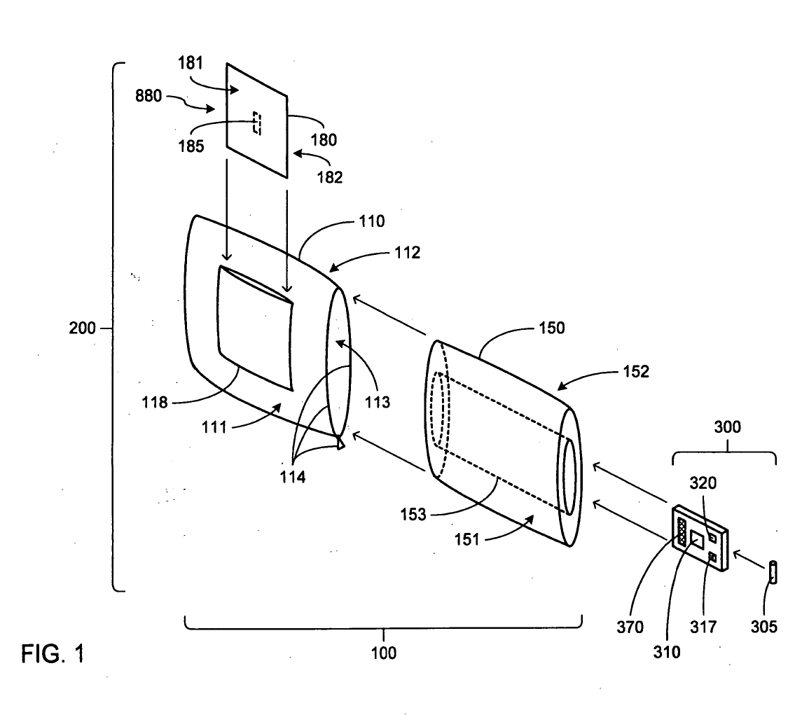

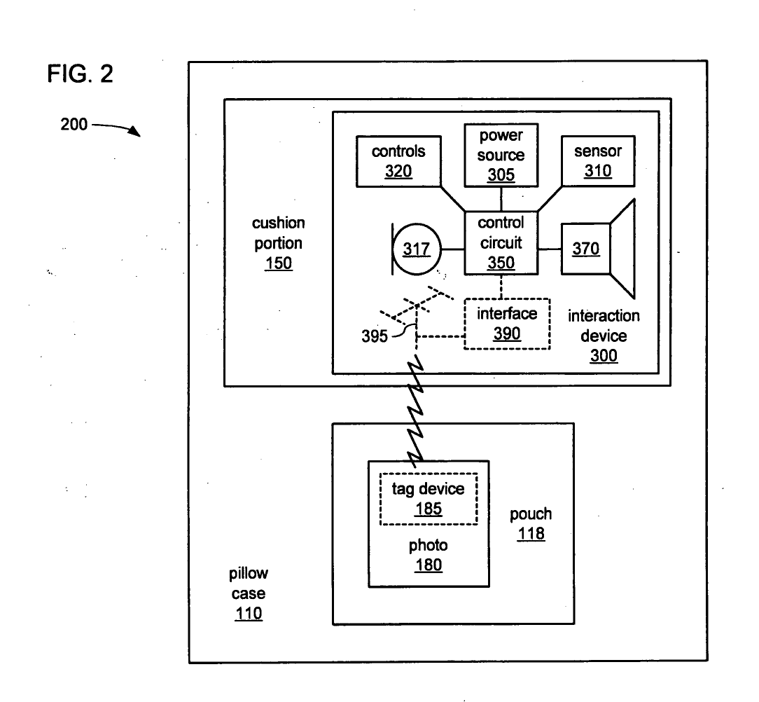

Referring to FIGS. 1 and 2, a patient comfort pillow for providing comfort or other appreciated emotion to a patient with imagery and associated audio is indicated by the numeral 200. The patient comfort pillow 200 may include a pillow portion 100 and an interaction device 300 carried within the pillow portion 100. The pillow portion 100 provides a relatively soft structure that is relatively unlikely to inflict injury to frail patients, and which is relatively easy for physically infirm patients to grasp or hold onto as by hugging. The interaction device 300 detects one or more specific types of physical handling of the pillow, portion 100 by a patient and responds by acoustically outputting one or more audio recordings.

The one or more audio recordings may be voices, music, environmental sounds and/or other sounds associated with a person, place or object depicted in an image 880 visually presented by the pillow portion 100. In embodiments in which the image 880 depicts a person, the person may be someone emotionally important to a patient to whom the patient comfort pillow 200 is provided, including a friend or relative, either living or dead. An audio recording associated with the image 880 may be of that person's voice saying something specifically to the patient, such as a “get well soon” message or the like.

Turning to FIG. 1, the pillow portion 100 may include a cushion portion 150 having at least a first surface 151 and a second surface 152, and may be shaped to define an interior space 153 within which at least a portion of the interaction device 300 may be carried. The cushion portion 150 may be formed from any of a variety of types of relatively soft material, including and not limited to, any of a variety of types of foam (e.g., polyurethane foam, latex foam, melamine foam, etc.), bunched fiber material (e.g., cotton, wool, etc.), or down feathers and the like. The soft material from which the cushion portion 150 is formed may be lined or encased within an inner cover (not shown) to aid in giving the cushion portion 150 its shape.

The interior space 153 defined by the shape of the cushion portion 150 provides a location within which at least a portion of the interaction device 300 may be carried in a manner in which it is at least partly surrounded by the soft material of the cushion portion 150. This surrounding of at least a portion of the interaction device 300 by the soft material may afford at least some degree of protection against physical impacts that may result from occasional dropping of the patient comfort pillow 200 by physically infirm patients onto floors and/or other hard surfaces. Alternatively or additionally, such surrounding of at least a portion of the interaction device 300 by the soft material of the cushion portion 150 may afford some degree of protection to patients suffering conditions such as arthritis or a relatively high susceptibility to bruising of the skin and/or other tissues by providing a soft object to grasp or otherwise hold onto.

The pillow portion 100 may further include a pillow case 110 having at least a first outer surface 111 and a second outer surface 112, and defining an interior space 113 into which the cushion portion 150 may be inserted. The pillow case 110 may be formed from any of a variety of types of fabric and/or other flexible material with which the cushion portion 150 may be surrounded, including and not limited to, any of a variety of fabrics incorporating natural and/or synthetic fibers (e.g., cotton, wool, poly-cotton blends, etc.), or permeable or impermeable plastic sheet material. The pillow case 110 separates the cushion portion 150 from direct contact with patients, becoming a portion of the pillow portion 100 that is able to be most easily laundered on a relatively frequent basis to maintain a hygienic quality of the pillow portion 100, while allowing the cushion portion 150 to be laundered less frequently.

As depicted, the pillow case 110 may include a zipper 114 or other closure mechanism disposed about an opening formed through a portion of the pillow case 110 to enable the cushion portion 150 to be inserted into and retained within the interior space 113. Alternate enclosures may include hook-and-loop fasteners, buttons, adhesive tape, metallic snaps, etc.

At least one of the outer surfaces 111 and/or 112 may incorporate a pouch 118 into which a photograph 180 bearing an image 880 may be inserted. The pouch 118 may be formed at least partly of transparent material to enable the image 880 to be viewed while the photograph 180 remains within the pouch 118, thereby enabling the patient comfort pillow 200 to be utilized to visually present the image 880. In some embodiments, at least a portion of the pouch 118 may be formed of flexible material that may differ in various characteristics from the flexible material from which the pillow case 110 is formed. By way of example, the pouch 118 may be at least partially formed of a substantially transparent material (e.g., a relatively transparent plastic, a fabric with a relatively sheer weave, etc.) that differs from a relatively opaque flexible material making up a substantial portion of the rest of the pillow case 110.

The image 880 may be carried on a first side 181 of the photograph 180. In some embodiments, the photograph 180 may incorporate a tag device 185 that may be carried on a second side 182 of the photograph opposite the first side 181, or may be embedded within the materials making up the photograph 180.

As depicted, the cushion portion 150 and the pillow case 110, together, may provide the pillow portion 100 with an elongate and bulging rectangular shape common to a great many typical pillows. Further, as depicted, the interior space 153 may be defined by the shape of the cushion portion 110 as extending lengthwise all the way through the cushion portion 110 from one end of the elongate and bulging rectangular shape to the other. However, despite the depiction of the pillow portion 100 as having such a shape, other embodiments are possible in which the pillow portion 100 may have any of a wide variety of other shapes. Also, despite the depiction of the interior space 153 as extending lengthwise between ends of such a shape, other embodiments are possible in which the interior space 153 may extend crosswise relative to the shape of pillow portion 100 and/or in which the interior space 153 extends only partly into the cushion portion 150.

Turning to FIG. 2, the interaction device 300 may include one or more of a power source 305, a sensor 310, a microphone 317, manually operable controls 320, a control circuit 350, an acoustic driver 370, an interface 390 and an antenna 395. The control circuit 350 may monitor the sensor 310 for an indication of one or more specific types of physical handling of the pillow portion 100 and may respond by operating the acoustic driver 370 to acoustically output an audio recording stored by the control circuit 350.

The power source 305 may include a battery or other electrical component able to store electrical energy to enable operation of the interaction device 300 without continuous coupling to AC mains or other power source external to the pillow component 100. In some embodiments, the power source 305 may alternatively or additionally include a solar cell, coil-type antenna or other component able to wirelessly collect radiant energy from an external source such as the Sun, interior lighting, electromagnetic fields specifically configured to wirelessly transmit electrical energy, etc.

The sensor 310 is selected and/or configured to detect one or more specific types of physical handling of the pillow portion 100 by a person holding the pillow portion 100. The sensor 310 may be any of a variety of types of sensor based on any of a variety of technologies. In some embodiments, the sensor 310 may include a pressure sensor and/or another type of sensor to sense physical squeezing, twisting, bending and/or other physical manipulation of the pillow portion 100 by a person. In other embodiments, the sensor 310 may include an accelerometer, a gyroscope and/or another type of sensor to sense physical movement of the pillow portion 100 by a person (e.g., shaking, tossing, rotating, etc.). As depicted, there is at least one sensor 310 disposed in relatively close proximity to other components of the interaction device 300 (e.g., within the same casing as other components of the interaction device 300). However, it should be noted that other embodiments are possible in which there is more than one sensor 310 and/or in which the sensor 310 is more physically separated from other components of the interaction device 300 (e.g., coupled to other components by a wire) to enable the sensor 310 to be positioned within the pillow portion 100 separately from other components of the interaction device 300.

The control circuit 350 may monitor the sensor 310 to receive signals therefrom indicating detection of the selected type(s) of physical handling that may have been selected for use as a trigger to cause the acoustic output of one or more audio recordings. In some embodiments, the control circuit 350 may respond to an indication of detection of the selected type(s) of physical handling by the sensor 310 relatively immediately by operating the acoustic driver 370 to acoustically output an audio recording. In other embodiments, the control circuit 350 may refrain from providing such acoustic output until the selected type(s) of physical handling have been detected as occurring throughout a selected minimum period of time. By way of example, the control circuit 350 may refrain from operating the acoustic driver 370 to acoustically output an audio recording until the sensor 310 detects that the pillow portion 100 has been squeezed continuously for at least half a second. Such imposition of a minimum period of time may be deemed desirable to prevent triggering of acoustic output of audio recordings in response to momentary squeezing of the pillow portion 100 arising from pushing of the pillow portion 100 about a bed or other piece of furniture. In this way, triggering of the acoustic output of the recorded audio requires a more deliberate and sustained squeezing of the pillow portion 100 that is more likely to be intended to cause such triggering.

The microphone 317, if present, may be any of a variety of types of microphone operable to allow an audio recording to be directly recorded by the interaction device 300. The microphone 317 may include one of a piezo-electric element, a carbon microphone, a dynamic microphone, or an electret microphone. The control circuit 350 may store more than one audio recording that may be recorded via the microphone 317.

The controls 320, if present, may be any of a variety of manually-operable controls, including and not limited to, one or more buttons, slide switches, toggle switches, rotary knob controls, joysticks, touch sensors, proximity sensors, etc. In some embodiments, at least one switch of the controls 320 may be operable as a power switch to selectively enable electric power to be supplied by the power source 305 to one or more other components of the interaction device 300.

In various embodiments, the control circuit 350 may monitor the controls 320 for indications of operation thereof to convey various commands to the control circuit 350. By way of example, the controls 320 may be operable to signal the control circuit 350 to cause the recording of an audio recording via the microphone 317 for subsequent acoustic output in response to the detection of the selected type(s) of physical handling of the pillow portion 100. By way of another example, the controls 320 may be operable to signal the control circuit 350 with an indication of a selection of one of multiple audio recordings to be acoustically output.

The acoustic driver 370 may be any of a variety of types of acoustic driver operable to acoustically output an audio recording. The acoustic driver 370 may include an electrostatic speaker, an electromagnetic speaker, a piezo-electric element, etc. In some embodiments, the microphone 317 and the acoustic driver 370 may be the same component (e.g., a piezo-electric or an electromagnetic speaker utilized to both record and acoustically output an audio recording).

The control circuit 350 may include any of a variety of electronic components able to monitor the sensor 310 for an indication of detection of selected type(s) of physical handling of the pillow portion 100, able to monitor the controls 320 for an indication of manual operation to convey a command, able to operate the microphone 317 to record an audio recording, and/or able to operate the acoustic driver 370 to acoustically output an audio recording. In some embodiments, the control circuit 350 may include gate array and/or discrete logic configured via programmed and/or physically implemented electrical connections to perform such monitoring and/or operation of other components of the interaction device 300. In other embodiments, the control circuit 350 may include a processor component (e.g., a central processing unit, a microcontroller, a digital signal processor, a sequencer, etc.) executing a sequence of instructions that cause the processor component to perform such monitoring and/or operation of other components of the interaction device 300.

The control circuit 350 may store more than one audio recording and may select one of those audio recordings to be acoustically output based on any of a variety of factors. In some embodiments, the sensor 310 may be selected and/or configured to detect more than one selected type of physical handling of the pillow portion 100 and the control circuit 350 may select an audio recording from among multiple audio recordings to acoustically output based on which selected type of physical handling is detected. In other embodiments, the control circuit 350 may incorporate a timing circuit able track the passage of time such that the control circuit 350 is provided with indications of a time of day, a day of a week, a date, etc. In such other embodiments, the control circuit 350 may select an audio recording from among multiple audio recordings to be acoustically output based on a time of day, a day of a week, a date, etc.

In embodiments in which the control circuit 350 selects from among multiple audio recordings, the control circuit 350 may monitor the controls 320 to receive indications of data to be utilized in making such a selection. By way of example, the controls 320 may be manually operable to provide the control circuit 350 with an indication of the current time of day, current day of the week and/or current date, as well as an indication of what audio recording to select to be acoustically output based on the arrival of a particular time of day, day of week and/or date. By way of another example, the controls 320 may be manually operable to provide the control circuit 350 with an indication of what audio recording to select in response to each type of physical handling of the pillow portion 100 that is selected to serve as a trigger to acoustically output an audio recording.

In embodiments in which more than one audio recording is stored by the control circuit 350, the audio circuit 350 may randomly select audio recordings to be acoustically output. This may be done to avoid a “broken record” effect in which the same words are always spoken by a person appearing in the photo 180, and/or the same environmental sounds and/or music sounds associated with a place appearing in the photo 180 are acoustically output in response to physical handling of the pillow portion 100. Alternatively or additionally, the control circuit 350 may vary the duration of acoustic output based on how frequently or for how long physical handling of the pillow portion 100 that triggers acoustic output occurs. More specifically, more frequently physical handling and/or physical handling that occurs for a longer period of time may serve as a trigger for the control circuit 350 randomly select and combine multiple audio recordings to be acoustically output, one after the other, to cause acoustic output that lasts for a longer period of time than if only one of the audio recordings was acoustically output.

Thus, repeated instances of physical handling of the pillow portion 100 over a relatively short time may be employed by the control circuit 350 to trigger acoustically outputting multiple audio recordings. Alternatively or additionally, a single protracted instance of physical handling of the pillow portion 100 may be employed by the control circuit 350 as such a trigger. The effect may be that more is “said” using the voice of a person appearing in the photo 180, that more music associated with a person or place appearing in the photo 180 is played, and/or that more environmental sounds associated with a place appearing in the photo 180 are played. By way of example, the control circuit 350 may store numerous audio recordings of music of a specific genre, spoken verses of scripture, spoken poems, well known “one liners” spoken aloud and/or other sounds associated with a depicted person, place and/or object, and may randomly select and acoustically output multiple ones thereof.

In embodiments in which the photo 180 incorporates the tag device 185, the control circuit 350 may operate the interface 390 to detect and interact with the tag device 185. The tag device 185 may be a radio frequency identification (RFID) tag device able to wirelessly transmit an identifier that may be uniquely associated with the image 880 to the interaction device 300 in response to being wirelessly provided with electrical power. Correspondingly, the interface 390 may cooperate with the power source 305 and the antenna 395 to selectively wirelessly provide electric power to the tag device 185 by generating an electromagnetic field under the control of the control circuit 350. The control circuit 350 may then also operate the interface 390 to exchange one or more commands and/or other protocol signals with the tag device 185 (via the antenna 395) to retrieve the identifier therefrom.

In embodiments in which the tag device 185 provides an identifier uniquely associated with the image 880, the control circuit 350 may select an audio recording to acoustically output at least partly based on the identifier. This may be desired where the photograph 180 is one of multiple photographs that may be inserted into the pouch 118 such that the image 880 thereof is one of multiple possible images that may thereby be visually presented by the pillow portion 100. Unique identifiers associated with each of those images may enable the control circuit 350 to select an audio recording for acoustic output that is associated with whichever one of those images is currently visually presented by the pillow portion 100 as a result of the insertion of whichever one of the multiple photographs into the pouch 118.

By way of example, where a current date is a birthday of a person who is significant to a patient, a photograph 180 bearing an image 880 of that person may be inserted into the pouch 118 to enable that image of that person to be visually presented to the patient by the pillow portion 100. The tag device 185 of that photograph 180 may then transmit an identifier to the interaction device 300 that uniquely identifies the image 880 that the photograph 180 bears and that is now visually presented by the pillow portion 100. In response to receiving the identifier, and in response to detecting a selected type of physical handling of the pillow portion 100 by the patient, the control circuit 350 employs the identifier to select an audio recording associated with that image person and acoustically outputs it via the acoustic driver 370 to the patient. In such an example, the selected audio recording may be of that person's voice, perhaps recorded by the interaction device 300 by that person speaking into the microphone 317.

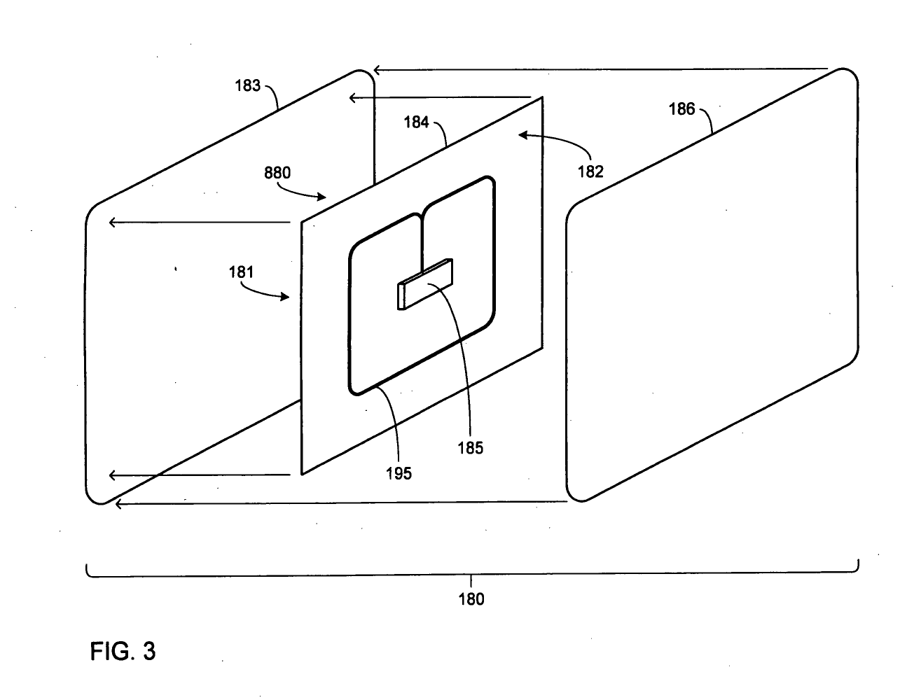

Referring to FIG. 3, in embodiments in which the photograph 180 incorporates the tag device 185, the photograph 180 may incorporate a photographic substrate 184 (e.g., photographic paper, film, etc.) bearing the image 880 and the tag device 185 on opposite sides 181, 182 thereof. The photographic substrate 184 may be laminated between a first protective sheet 183 providing the first surface 181 of the photograph 180 and a second protective sheet 186 providing the second surface 182 of the photograph 180. At least the first protective sheet 183 may be formed from a substantially clear material (e.g., a transparent plastics material) to enable the image 880 to be viewed there through.

It may be deemed desirable to enclose the photographic substrate 184 between the first and second protective sheets 183, 186 to address the possibility of the photograph 180 accidentally being laundered along with the pillow case 110. The first and second protective sheets 183, 186 may provide the image 880 carried by the photographic substrate 184 and/or the tag device 185 with at least some degree of protection from the moisture, chemical detergents and/or heat of a typical laundering process.

As depicted, the tag device 185 may be adhered or otherwise affixed to a side of the photographic substrate 184 along with an antenna 195 that is electrically connected to the tag device 185 to enable reception of wirelessly provided electric power and to enable transmission of an identifier to the interaction device 300. However, as familiar to those skilled in the art of RFID and/or other near-field communications (NFC) technology, other embodiments are possible in which the antenna 195 may be of a significantly smaller size such that it may be incorporated within the tag device 185, depending on such factors as the strength of the electromagnetic field utilized to convey electric power and/or the frequency at which the identifier is transmitted.

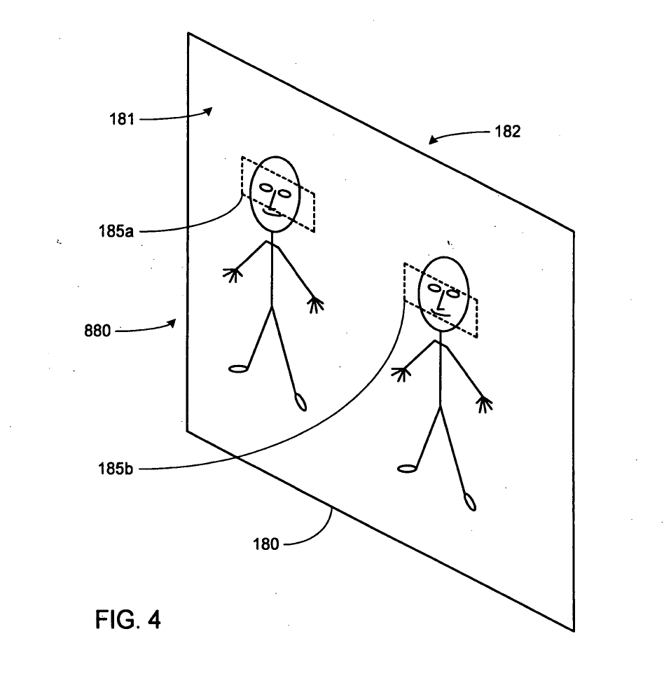

Referring to FIG. 4, in some embodiments, the photograph 180 may incorporate more than one of the tag devices 185, specifically, tag devices 185a and 185b. As depicted, the image 880 may include a depiction of more than one person. As also depicted, each of the tag devices 185a and 185b may be affixed (by adhesive or in some other manner) to the side 182 opposite the side 181 bearing the image 880 at locations co-located with the image of one of the multiple, persons depicted in the image 880. In such embodiments, each of the tag devices 185a and 185b may be configured to transmit an identifier associated with whichever person that each is co-located with the image of. Further, each of the tag devices 185a and 185b may incorporate a pressure sensor and/or other type of sensor that enables detection of when physical handling is directed at the image of a particular person in the image 880.

By way of example, the tag device 185a may be affixed to the side 182 of the photograph 180 opposite the side 181 bearing the image 880 at a location that is co-located with the face of a child of a patient to enable detection of when the image of that child within the image 880 is pressed, touched or otherwise physically handled by the patient with a fingertip or other body portion. The tag device 185a may then wirelessly transmit both an identifier uniquely associated with the child (or of the image of the child) and an indication of detecting physical handling of the image of that child (e.g., the pressing of a fingertip of the patient against the image of that child) to the interaction device 300. In response to receiving these wirelessly transmitted indications, the interaction device 300 may use the identifier to select an audio recording that includes the voice of that child and may acoustically output that audio recording.

Referring back to FIG. 2 in conjunction with FIG. 4, as familiar to those skilled in the art of RFID technology, the wireless provision of electric power via a magnetic field is a relatively inefficient mechanism to convey electric power. Thus, operation of the interface 390 and the antenna 395 to generate an electromagnetic field with sufficient strength to effectively convey electric power to the tag devices 185a and 185b likely consumes electric power from the power source 305 at a relatively high rate that cannot be sustained for extended periods in embodiments in which the power source 305 is a battery or other component that stores a relatively limited amount of electric power. As a result, it may be deemed impractical to continuously generate such an electromagnetic field to enable the tag devices 185a and/or 185b to continuously monitor sensor(s) thereof for an indication of physical handling of a portion of the image 880 (e.g., touching with a fingertip, etc.), as well as to enable the tag devices 185a and/or 185b to transmit such an indication to the interaction device 300.

As an alternative to continuously generating such an electromagnetic field, in some embodiments, the control circuit 350 may continuously monitor the sensor 310 for an indication of detecting physical handling of the pillow portion 100, which may be an indication of physical handling of a portion of the image 880. In response to that indication, the control circuit 350 may then operate the interface 390 to generate an electromagnetic field to wirelessly provide electric power to the tag devices 185a and/or 185b. The control circuit 350 may also operate the interface 390 to be ready to receive an indication of physical handling of a portion of the image 880 detected by the tag devices 185a and/or 185b. Upon being wirelessly provided with electric power, each of the tag devices 185a and 185b may employ their own sensor(s) to provide confirmation of whether or not the physical handling of the pillow portion 100 detected by the sensor 310 includes physical handling of a portion of the image 880 (e.g., a touch of a portion of the image 880 with a fingertip) at a location co-located with one of the tag devices 185a or 185b.

If the detected physical handling includes physical handling directed at a portion of the image 880 co-located with the tag device 185a, for example, then the tag device 185a may wirelessly transmit an indication of having detected such physical handling along with an identifier to the interaction device 300. Upon receiving the indication from the tag device 185a of the physical handling (through the interface 390 and the antenna 395) and the identifier, the control circuit 350 may employ the identifier to select an audio recording associated with the person depicted in the portion of the image 880 at which the physical handling was directed, and may operate the acoustic driver 370 to acoustically output that audio recording.

Thus, in such embodiments, the electromagnetic field is generated only in response to the detection of possible physical handling of the pillow portion 100 by the sensor 310, and that may include physical handling directed at a portion of the image 880 by a patient seeking to hear an audio recording associated with the image of a person or other object in the image 880 at the location within the image 880 to which the physically handling is directed. As a result, the single image 880 may include, for example, an image of a group picture of multiple family members and/or friends, and co-located with the images of individual ones of the family members or friends may be individual tag devices 185 (e.g., the tag devices 185a and 185b). Thus, each of those tag devices 185 may be uniquely associated with a different one of the depicted family members and/or friends to enable a touch or other physical handling of any one of the images of a family member or friend within the image 880 to be individually detected and responded to with the acoustic output of an audio recording associated with that particular family member or friend.

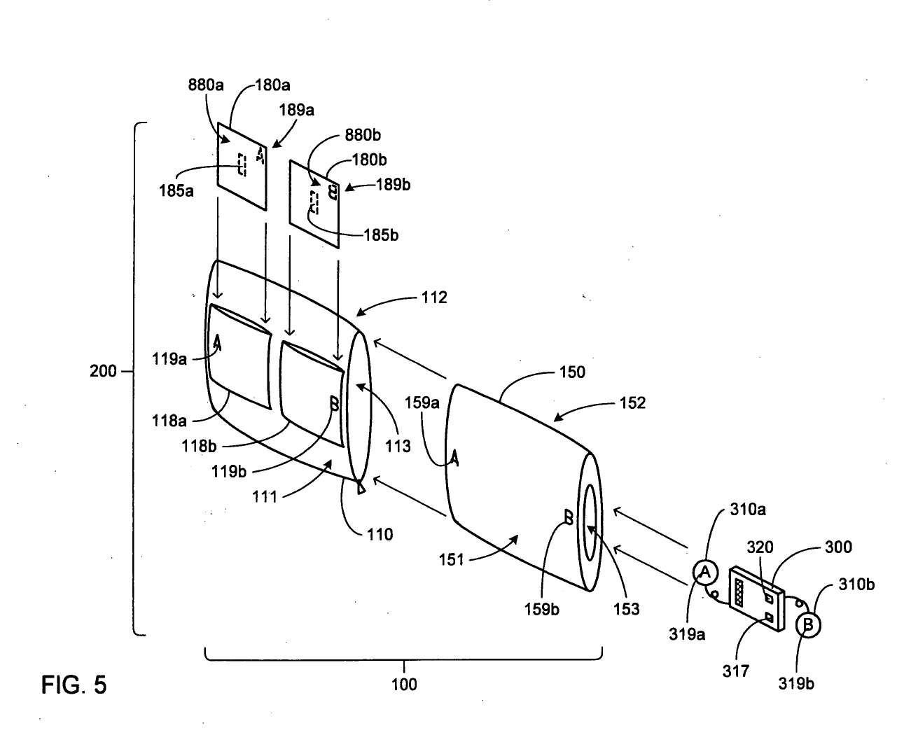

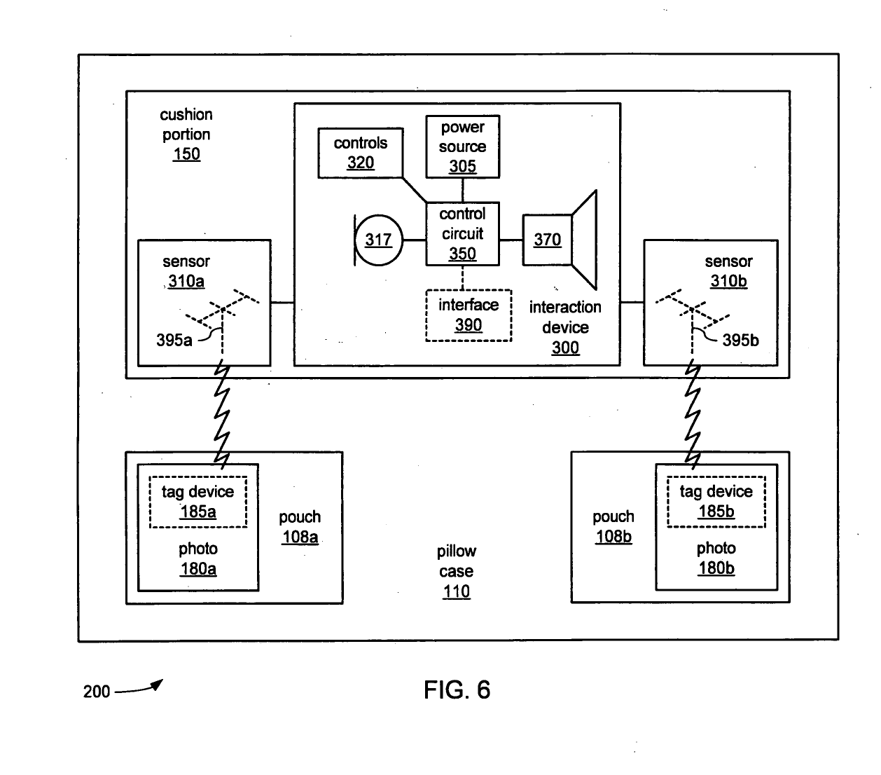

Referring to FIGS. 5 and 6, in an alternate embodiment of the patient comfort pillow 200, an alternate embodiment of the pillow case 110 may incorporate more than one pouch 118 and an alternate embodiment of the interaction device 300 may incorporate more than one sensor 310. Specifically, and as depicted, the pillow case 110 may incorporate a pair of pouches 118a and 118b to hold a pair of photographs 180a and 180b bearing images 880a and 880b, respectively. As also depicted, the interaction device 300 may include a pair of sensors 310a and 310b that may be coupled by wires to other components of the interaction device 300, thereby allowing independent positioning of each of the sensors 310a and 310b within the pillow portion 100.

Turning to FIG. 5, the photographs 180a and 180b may carry indicia 189a and 189b and the pillow case 110 may carry corresponding indicia 119a and 119b, respectively, to aid in correctly matching the photographs 180a and 180b with corresponding ones of the pouches 118a and 118b, respectively. Additionally, the sensors 310a and 310b may carry indicia 319a and 319b and the cushion portion 150 may carry indicia 159a and 159b, respectively, to aid in correctly co-locating the sensors 310a and 310b with the pouches 118a and 118b, respectively. Thus, a person reassembling the patient comfort pillow 200 following laundering of the pillow case 110 and/or the cushion portion 150 may be assisted in doing so such that the sensor 310a is positioned to detect physical handling directed at the photograph 180a and the sensor 310b is positioned to detect physical handling directed at the photograph 180b.

Turning to FIG. 6, in some embodiments, the control circuit 350 may store separate audio recordings, one associated with the pouch 118a and the other associated with the pouch 118b. The control circuit 350 may monitor both of the sensors 310a and 310b for indications of detecting physical handling of the pillow portion 100 that includes physical handling directed at one or the other of the pouches 118a or 118b. Upon receiving an indication from the sensor 310a, for example, of physical handling directed towards the pouch 118a (presuming that the sensor 310a is correctly co-located with the pouch 118a), the control circuit 350 selects an audio recording associated with the photograph 180a (presuming that the photograph 180a is correctly inserted into the pouch 118a, as expected), and operates the acoustic driver to acoustically output that audio recording.

However, as also depicted in FIGS. 5 and 6, the photographs 180a and 180b may incorporate the tag devices 185a and 185b, respectively. Each of the tag devices 185a and 185b may be configured to transmit an identifier unique to its respective one of the photographs 180a and 180b. Further, each of the tag devices 185a and 185b in FIGS. 5 and 6 may incorporate a pressure sensor or other sensor to detect physical handling directed at a corresponding one of the photographs 180a and 180b.

As earlier discussed with regard to FIG. 4, it may be deemed impractical to continuously generate an electromagnetic field to wirelessly provide electric power to the tag devices 185a and 185b in the alternate embodiment of the patient comfort pillow 200 of FIGS. 5 and 6. Thus, the control circuit 350 may monitor the sensors 310a and 310b for an indication of physical handling directed at one or the other of the pouches 118a or 118b, respectively (presuming that the sensors 310a and 310b are correctly positioned in the vicinity of the pouches 118a and 118b, respectively).

If the detected physical handling includes physical handling detected as directed at the pouch 118a, for example, then the control circuit 350 may operate the interface 390 to generate an electromagnetic field to wirelessly provide power. In some embodiments, the interaction device 300 may incorporate the single antenna 395, which may be co-located with the interface 390 in a manner similar to what was depicted in FIG. 2. However, in other embodiments, the single antenna 395 may be replaced with antennae 395a and 395b co-located with the sensors 310a and 310b, respectively. The provision of such separate antennae 395a and 395b that would be co-located with corresponding ones of the pouches 118a and 118b (if positioned correctly) may be deemed desirable to enable conservation of electric power from the power source 305 by enabling the generation of a smaller electromagnetic field that is more localized to the vicinity at which physical handling was detected by one of the sensors 310a or 310b. Thus, the control circuit 350 may select the antenna 395a for use with the interface 390 to generate a more localized electromagnetic field in the vicinity of the pouch 118a in response to the physical handling having been detected by the sensor 310a, and not the sensor 310b.

If the detected physical handling includes physical handling directed at the image 880a of the photograph 180a, then the tag device 185a may wirelessly transmit an indication of having detected such physical handling along with an identifier associated with the image 880a to the interaction device 300. Upon receiving the indication from the tag device 185a of the physical handling (through the interface 390 and the antenna 395a) and the identifier, the control circuit 350 may employ the identifier to select an audio recording associated with the image 880a, and may operate the acoustic driver 370 to acoustically output that audio recording.

Such use of tag devices incorporated into photographs in the embodiments of FIGS. 1 through 6 may enable the changing of what audio recordings may be acoustically output by simply changing what photographs are used. This may be deemed advantageous as it may enable the changing of which audio recording is acoustically output based on seasons of the year, the coming of a holiday or anniversary of event, etc. by simply changing one or more photographs inserted into one or more pouches. By way of example, upon the approach of Winter, the photograph 180 may be changed to change the image 880 from one depicting a person dressed for Fall and/or a scene captured at a location during Fall to another depicting that person dressed for Winter (perhaps engaging in a Winter-related activity) and/or a scene captured at the same location during Winter. The change in photographs 180 results in a corresponding change in tag devices 185 such that a different identifier is wirelessly transmitted to the interaction device to cause a selection of a different audio recording that is in some way associated with Winter (e.g., an audio recording of the person depicted in the image 880 singing a song associated with a Winter holiday).

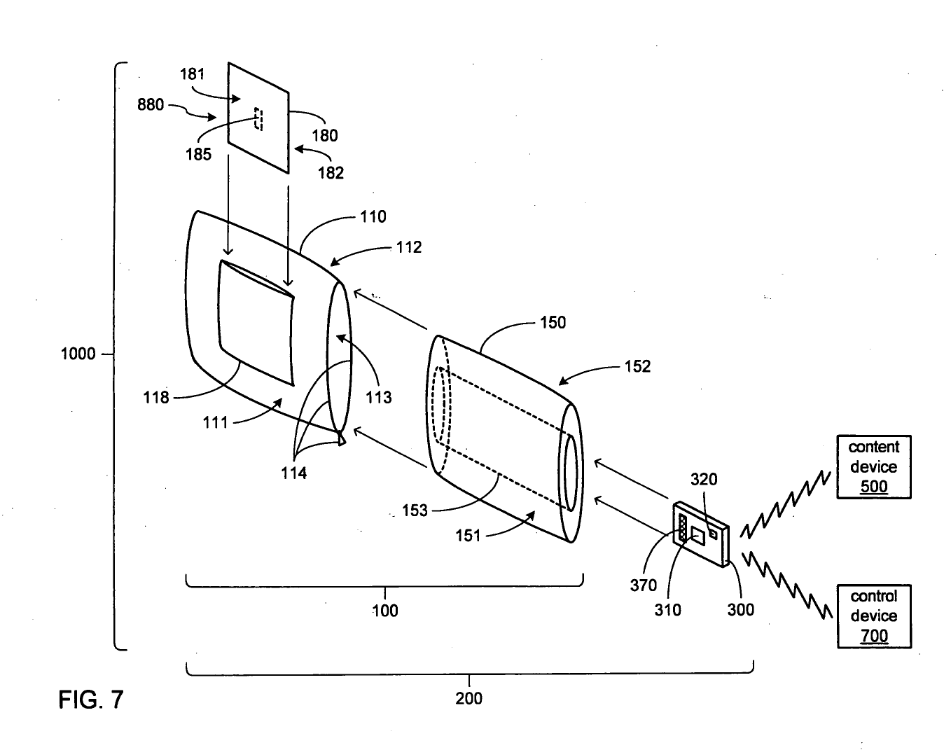

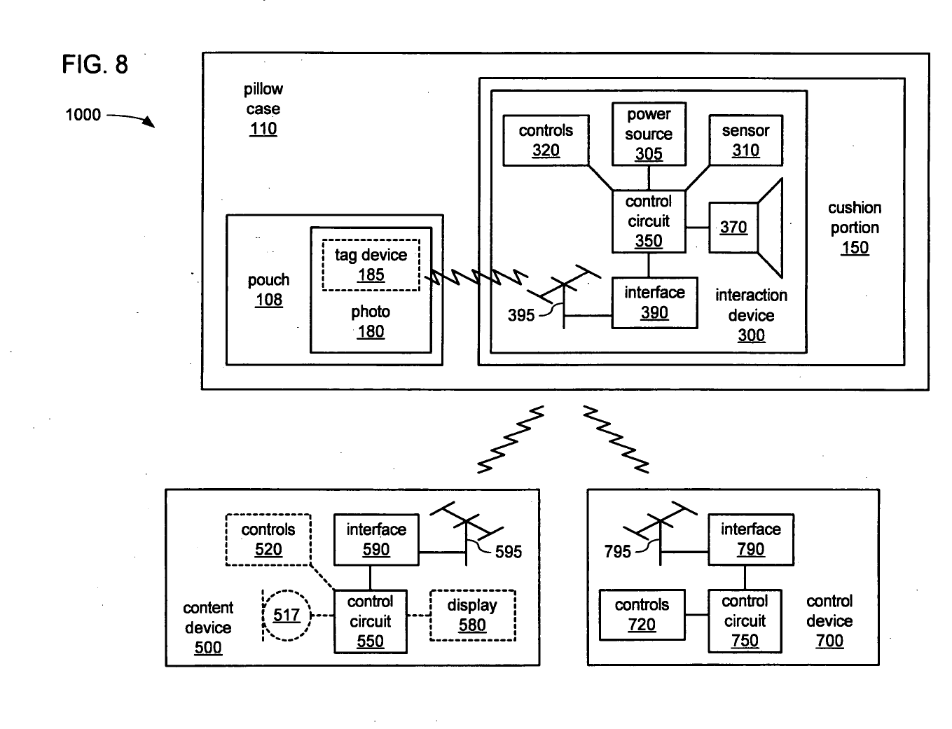

Referring to FIGS. 7 and 8, an embodiment of a patient comfort system that includes another alternate embodiment of the patient comfort pillow 200 is indicated by the numeral 1000. The patient comfort system 1000 may additionally include a content device 500 and/or a control device 700 configured to engage in wireless communications with the interaction device 300. The content device 500 may wirelessly transmit audio recordings to the interaction device 300 and/or set one or more parameters for triggering the acoustic output of one or more audio recordings. The control device 700 may provide the ability to remotely activate or deactivate the acoustic output of audio recordings.

The content device 500 and the control device 700 may each be any of a variety of computing devices, including and not limited to, a desktop or laptop computer system; a server or node of a server farm; a smartphone or tablet computer; a smart watch or smart glasses; or a wireless remote control device specifically configured to wirelessly communicate with the interaction device 300. In some embodiments, the pillow portion 100, the interaction device 300 and one or both of the content device 500 and the control device 700 (e.g., at least a portion of the patient comfort system 1000) may be offered for sale and/or offered by a medical facility as a kit for providing emotional comfort to a patient. In other embodiments, a conventional smartphone, tablet computer or other mobile device may be caused to become the content device 500 and/or the control device 700 via the installation and execution of applications software (e.g., an “app” downloaded thereto from a server).

Turning more specifically to FIG. 8, the content device 500 may incorporate a microphone 517, controls 520, a control circuit 550, a display 580, an interface 590 and an antenna 595. The control device 700 may incorporate controls 720, a control circuit 750, an interface 790 and an antenna 795.

The microphone 517, if present, may be any of a variety of types of microphone operable to allow audio recordings meant to be acoustically output by the interaction device 300 to be recorded by the content device 500. The microphone 517 may include one of a piezo-electric element, a carbon microphone, a dynamic microphone, or an electret microphone. Thus, new audio recordings may be generated using the content device 500, and then remotely transmitted to the interaction device 300 to be incorporated into a selection of audio recordings stored in within the interaction device 300 for acoustic output.

The controls 520, if present, may be any of a variety of manually-operable controls, including and not limited to, one or more buttons, slide switches, toggle switches, rotary knob controls, joysticks, touch sensors, proximity sensors, etc. In various embodiments, the control circuit 550 may monitor the controls 520 for indications of operation thereof to convey various commands to the control circuit 550. By way of example, the controls 520 may be operable to signal the control circuit 550 to cause recording of one or more audio recordings via the microphone 517 in preparation for subsequent acoustic output by the interaction device 300 in response to the detection of selected type(s) of physical handling of the pillow portion 100.

The display 580, if present, may be any of a variety of types of display based on any of a variety of technologies, including and not limited to, liquid crystal display (LCD) technology, electroluminescent (EL) technology, light-emitting diode (LED) technology, gas plasma technology, etc. The control circuit 550 may operate the controls 520 and the display 580 together to provide a user interface enabling an operator of the content device 500 to remotely configure various aspects of the operation of the interaction device 300. Indeed, in some embodiments, the controls 520 and the display 580 may be combined to form a touch-screen display. The provided user interface may enable an operator of the content device 500 to select conditions under which different ones of multiple audio recordings may be acoustically output by the interaction device 300. By way of example, different audio recordings may be selected to be acoustically output at different times of a day, different days of a week, and/or on specific dates of a year. By way of another example, different audio recordings may be selected to be acoustically output in response to different selected types of physical handling such as a squeezing of the pillow portion 100 versus a shaking action, or such as pressing against one part of the pillow portion 100 versus another part (e.g., pressing against one pouch versus another).

The controls 720, if present, may be any of a variety of manually-operable controls, including and not limited to, one or more buttons, slide switches, toggle switches, rotary knob controls, joysticks, touch sensors, proximity sensors, etc. In various embodiments, the control circuit 750 may monitor the controls 720 for indications of operation thereof to convey various commands to the control circuit 750. By way of example, the controls 720 may be operable to signal the control circuit 750 to, in turn, signal the interaction device 300 to either acoustically output audio recording(s) in response to physical handling of the pillow portion 100 or to refrain from doing so. By way of example, the control device 700 may be provided to the medical staff of a medical facility to enable them to remotely cause the interaction device 300 to refrain from acoustically outputting recorded audio at times when a quiet environment is desired, such as during the night when patients are sleeping.

The control circuits 550 and 750 may each include any of a variety of electronic components. In some embodiments, the control circuits 550 and/or 750 may include gate array and/or discrete logic configured via programmed and/or physically implemented electrical connections. In other embodiments, the control circuits 550 and/or 750 may include a processor component (e.g., a central processing unit, a microcontroller, a sequencer, etc.) executing a sequence of instructions.

The control circuit 550 may store more than one audio recording in preparation for transmitting one or more of them to the interaction device 300. In some embodiments, the control circuit 550 may incorporate a timing circuit able to track the passage of time such that the control circuit 550 is provided with indications of a time of day, a day of a week, a date, etc. In such other embodiments, the control circuit 550 may select one audio recording from among multiple audio recordings to transmit to the interaction device 300 to be acoustically output.

The interfaces 390, 590 and/or 790 may be operable to effect wireless communications among the interaction device 300, the content device 500 and/or the control device 700, respectively. In various embodiments, the interfaces 390, 590 and/or 790 may employ wireless communications having timings and/or protocols that conform to any of a variety of known and used RF wireless networking standards. Such standards may include, and are not limited to, the BLUETOOTH® specification promulgated by the Bluetooth Special Interest Group of Kirkland, Wash., and/or one or more of the various versions of the 802.11 series of wireless networking standards promulgated by the Institute of Electrical and Electronics Engineers® (IEEE) of Piscataway, N.J.

By way of example, the interaction device 300 may wirelessly communicate with the content device 500 via a wireless network installed at a medical facility at which a patient is staying who has been provided with the patient comfort pillow 200. The content device 500 may be carried by a family member of the patient, and may engage in communications with the interaction device 300 via that wireless network or in direct point-to-point wireless communications between the content device 500 and the interaction device 300 at times when the content device 500 is brought to the medical facility. At times when the content device 500 is more distant, the content device 500 and the interaction device 300 may engage in communications via the wireless network of the medical facility and via a connection between that wireless network and the Internet. The control device 700 may be capable of employing similar options in engaging in communications with the interaction device 300.

It should be noted that although the content device 500 and the control device 700 are depicted as separate devices, other embodiments are possible in which the functions of both are performed by a single device. Thus, for example, the patient comfort system 1000 may include an embodiment of the content device 500 that is also operable to remotely selectively enable and disable the acoustic output of an audio recording by the interaction device 300.

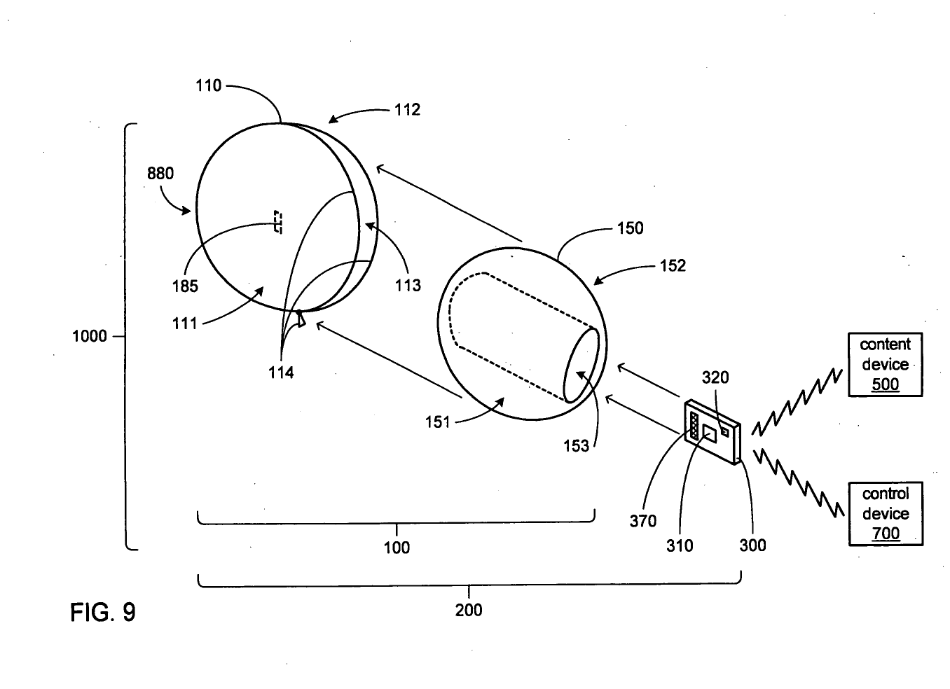

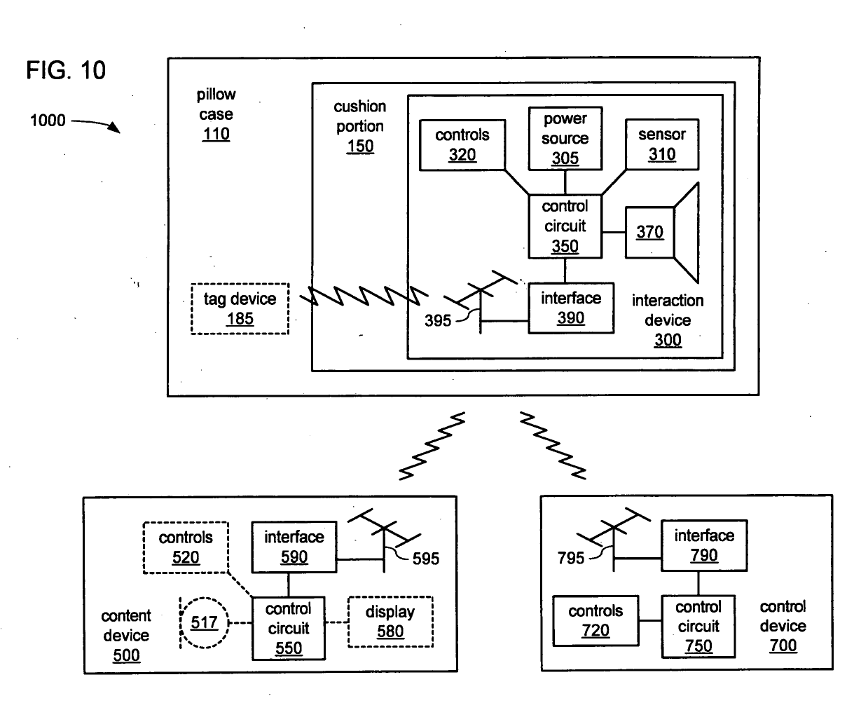

Referring to FIGS. 9 and 10, in an alternate embodiment of the patient comfort system 1000 that includes an alternate embodiment of the patient comfort pillow 200, the pillow portion 100 may have a rounded bulging shape, the interior space 153 may not extend all the way through the cushion portion 150, and the pillow case 110 may directly bear the image 880 on one or more of its outer surfaces 111 and/or 112. Specifically, FIG. 9 serves to make clear that the pillow portion 100 may have a shape other than the elongate and bulging rectangular shape depicted in the earlier figures. Further, as also depicted in FIG. 9, embodiments are possible in which the image 880 is printed onto, sewn into or is otherwise directly visually presented by at least the outer surface 111 of the pillow case 110 without use of a photograph or a pouch to hold a photograph.

As additionally depicted in FIGS. 9 and 10, in lieu of the use of photographs that may incorporate tag devices, the pillow case 110 may itself incorporate the tag device 185 such that the identifier that may be transmitted by the tag device 185 to the interaction device 300 may be uniquely associated with the pillow case and/or the image 880 carried by the pillow case 110. Thus, in embodiments in which the pillow case 110 incorporates the tag device 185 and in which the control circuit 350 employs the identifier received therefrom in selecting an audio recording, what audio recording is selected may be changed by changing the pillow case 110 for another one carrying a different tag device and bearing what may be a different image.

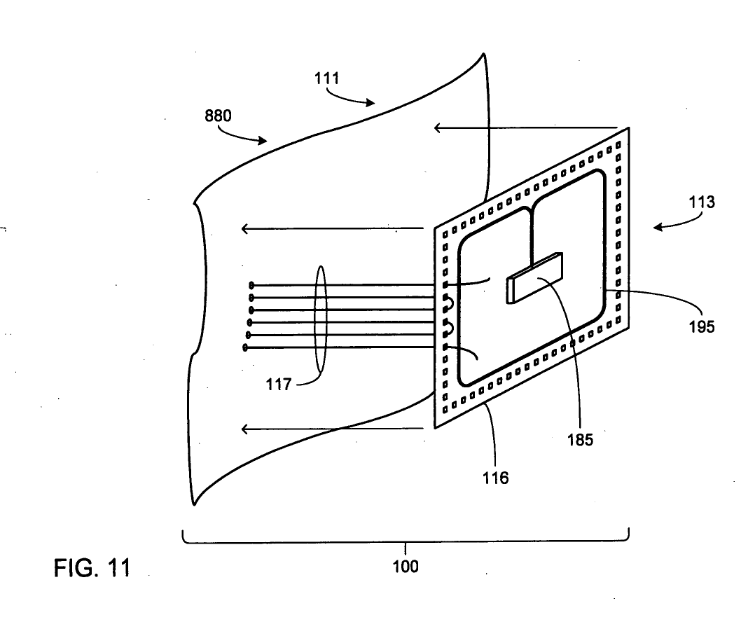

Referring to FIG. 11, in embodiments in which the pillow case 110 incorporates the tag device 185, the tag device 185 and an accompanying antenna 195 may be incorporated into a support substrate 116 that is affixed to the flexible material of the pillow case 110. As depicted, the support substrate 116 may be sewn onto a portion of the flexible material of the pillow case 110 using thread 117. In so doing, the support substrate 116 may be sewn to a surface of the flexible material opposite an outer surface (e.g., the outer surface 111) and that faces the interior space 113 into which the cushion portion 150 and the interaction device 300 are inserted such that the support substrate 116 and the tag device 185 are not normally visible when the patient comfort pillow 200 is assembled.

In other embodiments in which the tag device 185 incorporates the antenna 195 such that the support substrate 116 is not needed, the tag device 185 may be affixed to a surface of the pillow case that faces the interior space 113 via an adhesive. In still other embodiments, the tag device 185 may be sewn into a seam where portions of the flexible material of the pillow case 110 meet and are sewn together.

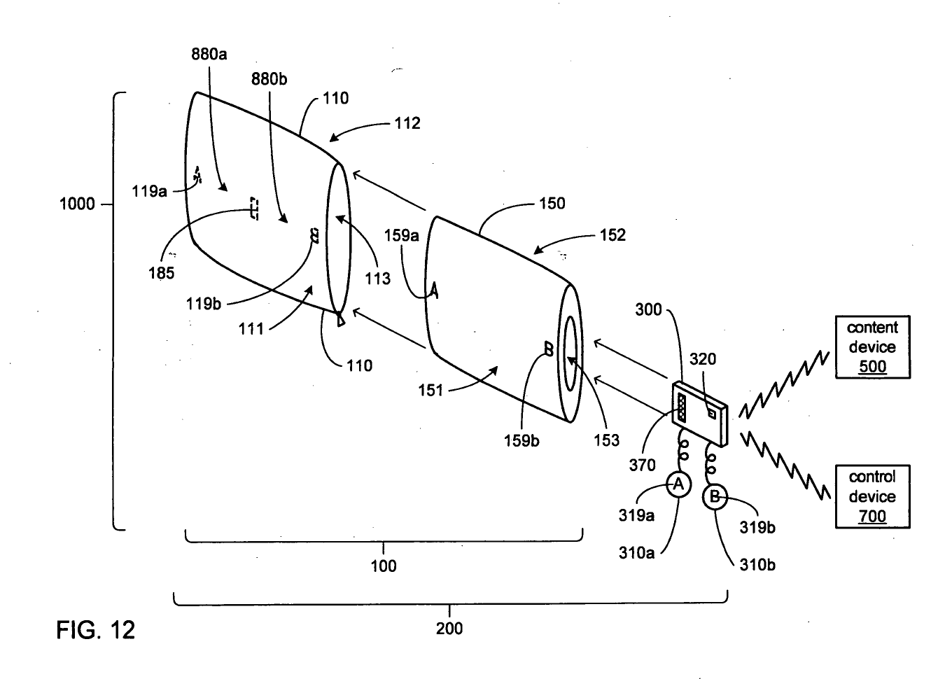

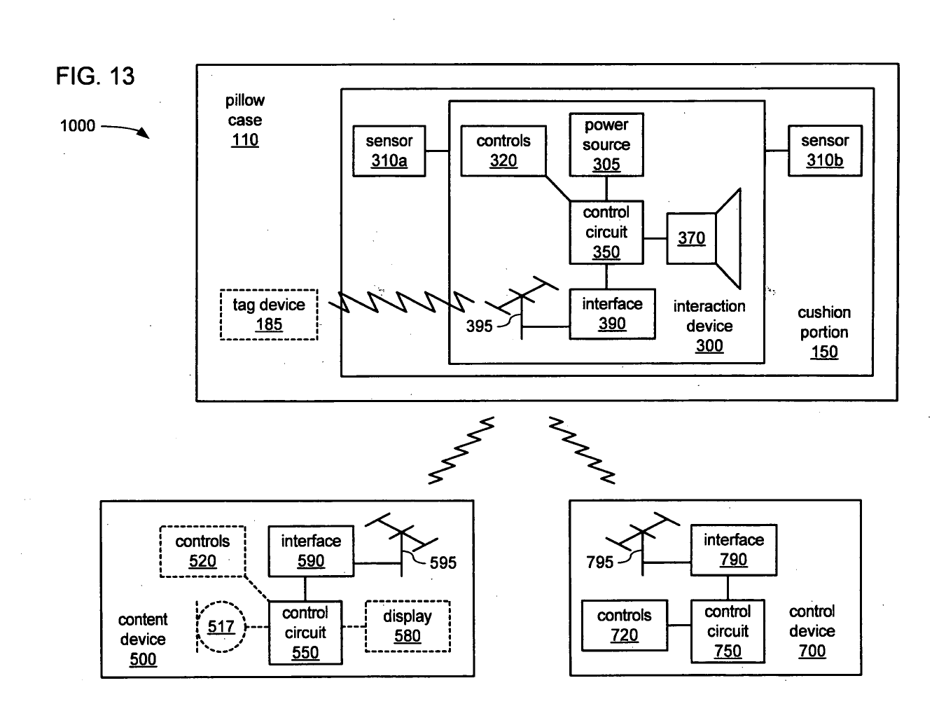

Referring to FIGS. 12 and 13, in another alternate embodiment of the patient comfort system 1000 that includes another alternate embodiment of the patient comfort pillow 200, the pillow case 110 may directly bear more than one image on an outer surface thereof, and the interaction device 300 may be coupled to a pair of sensors 310a and 310b by wires in a manner not unlike what was depicted in FIG. 5. Specifically, the interaction device 300 may employ the pair of sensors 310a and 310b to separately detect physical handling directed at different ones of images 880a and 880b, respectively, visually presented by different portions of an outer surface of the pillow case 110.

Further, and also in a manner not unlike what was depicted in FIG. 5, the pillow case 110, the cushion portion 150 and the sensors 310a and 310b may display indicia 119a-b, 159a-b and 319a-b, respectively. Again, it may be deemed desirable to provide such indicia to assist a person reassembling the patient comfort pillow 200 with correctly co-locating the sensors 310a and 310b with the locations of the pillow case 110 on which the images 880a and 880b, respectively, are visually presented. The indicia 119a and 119b may be visually presented on a surface of the flexible material of the pillow case that faces the interior space 113 defined by the pillow case 110 for sake of not detracting from the visual presentation of the images 880a and 880b on an outer surface (e.g., the outer surface 111).

In this way, the control circuit 350 is able to monitor the sensors 310a and 310b for indications of detected physical handling directed towards one or the other of the images 880a and 880b. The control circuit 350 may store separate audio recordings associated with each of the images 880a and 880b, and may select one of those audio recordings for acoustic output via the acoustic driver 370 depending on whether physical handling is directed toward the image 880a or the image 880b.

As also depicted in FIGS. 12 and 13, the pillow case 110 may incorporate a tag device 185 able to transmit an identifier to the interaction device 300 that uniquely identifies the pillow case 110. In this way, what audio recordings are acoustically output in response to physical handling detected by each of the sensors 310a and 310b may be changed by changing the pillow case 110 for another one carrying a different tag device and bearing what may be a different pair of images. Thus, for example, if the images 880a and 880b visually presented by the pillow case 110 are of scenes from a camping trip and of a trip to a beach associated with audio recordings of sounds captured during each occasion, other audio recordings associated with images of two family members may subsequently be selected for acoustic output by changing the pillow case 110 to one that visually displays a pair of images of those two family members.

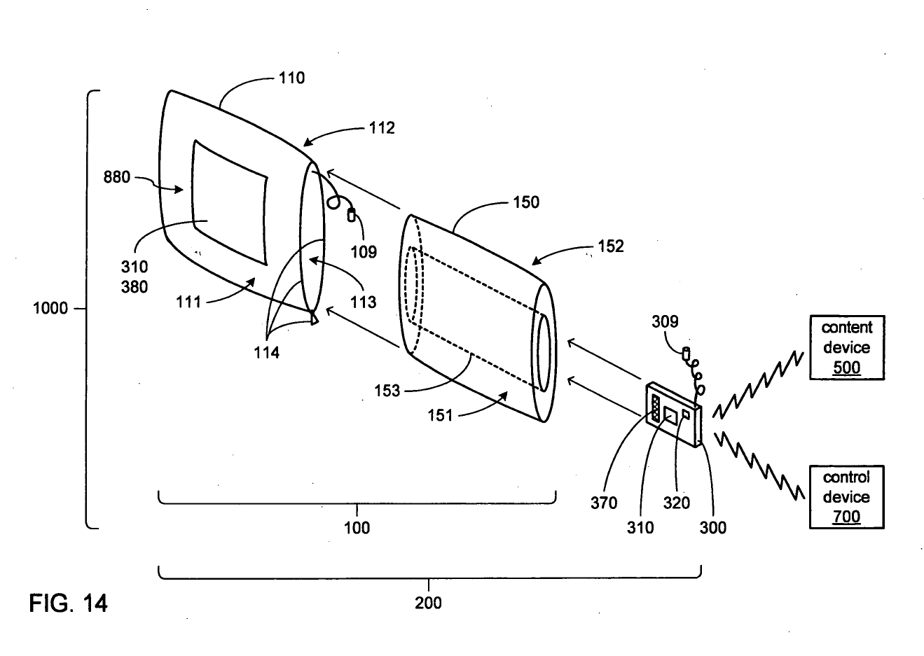

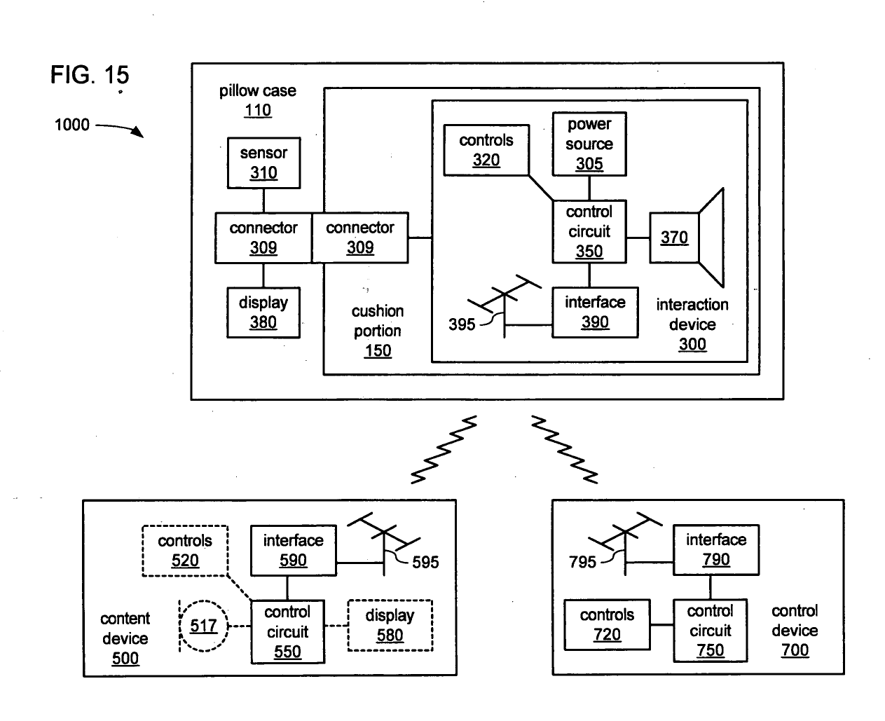

Referring to FIGS. 14 and 15, in still another alternate embodiment of the patient comfort system 1000 that includes still another alternate embodiment of the patient comfort pillow 200, the pillow portion 100 may additionally include a display 380 to visually present any of a variety of images 880, and the sensor 310 may be integrated into the display 380 such that the display 380 may be a touch-screen display. The display 380 and/or the sensor 310 may be coupled to other components of the interaction device 300 via wires that may be electrically connectable through the coupling of electrical connectors 109 and 309.

The display 380 may be any of a variety of types of display based on any of a variety of technologies. However, in an effort to avoid instances of broken displays resulting from clumsiness by physically infirm patients, it may be deemed desirable to employ a display technology that enables the display 380 to be a flexible display that may be more resistant to damage from physical impacts. Such a display technology may include, and is not limited to, electrophoretic technology (currently offered as E-Ink technology of E-INK™ Corporation of Cambridge, Mass.). As familiar to, those skilled in the art, electrophoretic technology and some other flexible display technologies have the ability to continue to display an image driven onto a display even after electric power is no longer provided to the display. Thus, once the control circuit 350 operates the display 380 to cause an image to be visually presented thereon, the control circuit 350 may act to conserve electric power stored by the power source 305 by withdrawing the provision of electric power to the display 380.

The control circuit 350 may operate the display 380 to visually present one or more images 880 of persons, objects and/or places that may have significance to a patient to whom the patient comfort pillow 200 is provided. In some embodiments, the control circuit 350 may store image data representing multiple images 880, and may operate the display 380 to change which of those stored images is visually presented on the display 380 at a random or regular interval. In some embodiments, the control circuit 350 may change the image 880 in response to a specific type of physical handling of the pillow portion 100 by the patient (e.g., a shaking the pillow portion 100 with a motion akin to what may be done to clear an image from an ETCH A SKETCH® toy of OHIO ART® of Bryan, Ohio).

The images 880 visually presented by the control circuit 350 on the display 380 may be remotely received from the content device 500. As will be explained in greater detail, the content device 500 may be operable to record one or more images 880 in addition to or in lieu of recording audio recordings. Further, in some embodiments, the sensor 310 may include an accelerometer, gyroscope and/or other sensors able to determine the orientation of the pillow portion 100 relative to the direction of the force of gravity in at least one dimension. In such embodiments, the control circuit 350 may change the orientation of the image 880 as visually presented on the display 380 to maintain the image 880 such that what is regarded as the “top” of the image 880 is oriented upward. Stated differently, the image 880 may be rotated in its visual presentation on the display 380 to keep it generally “right side up” in its visual presentation.

The control circuit 350 may monitor the sensor 310 for an indication of physical handling of the pillow portion 100 (e.g., squeezing or other physical manipulation of the pillow portion), and may respond to such an indication by selecting an audio recording associated with the image 880 currently visually presented on the display 380. In embodiments in which the sensor 310 is incorporated into or otherwise co-located with the display 380 to create a touch-sensitive display, the type of physical handling detected by the sensor 310 may include the touching of the display 380 with a finger or other portion of the body of a patient.

In some embodiments, and as depicted in FIG. 14, the display 380 and/or the sensor 310 may be incorporated into the pillow case 110. In such embodiments, an aperture may be formed through the flexible material of the pillow case 110 through which the display 380 may be visible, thereby enabling visual presentation of images at an outer surface of the pillow portion 100. Alternatively, the flexible material of the pillow case 110 may be of a sheer fabric weave and/or a transparent material through which the display 380 is visible. In other embodiments, the display 380 and/or the sensor 310 may be incorporated into the cushion portion 150, rather than into the pillow case 110. In such other embodiments, at least the portion of the pillow case 110 that overlies the display 380 may be made of a sheer fabric weave, a transparent material or with an aperture that enables the display 380 to be viewed through the pillow case 110.

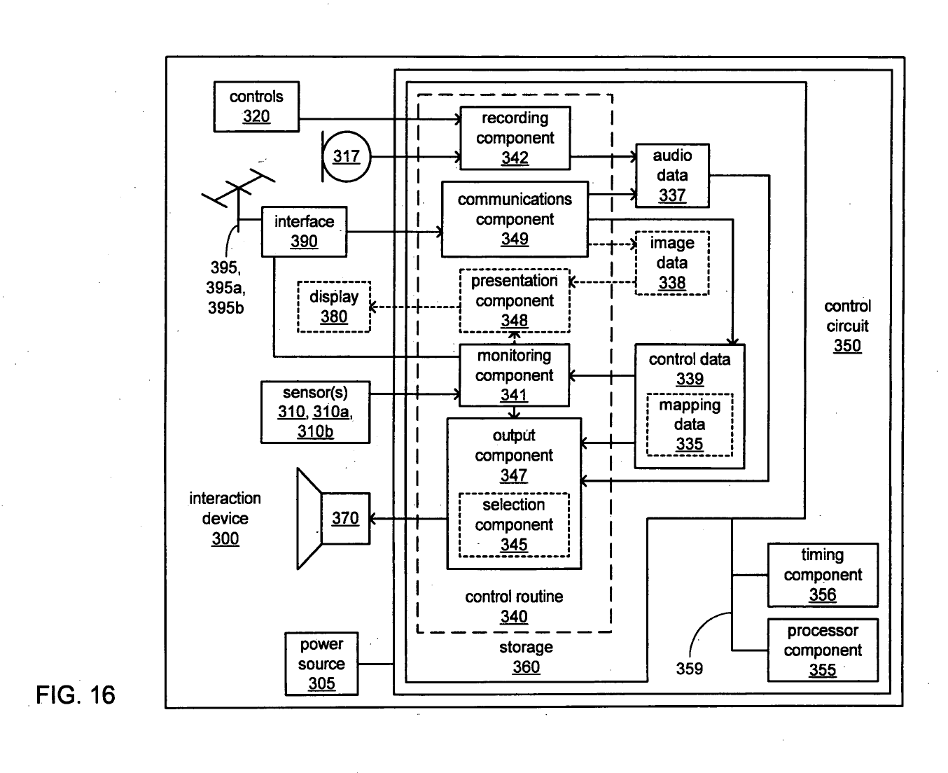

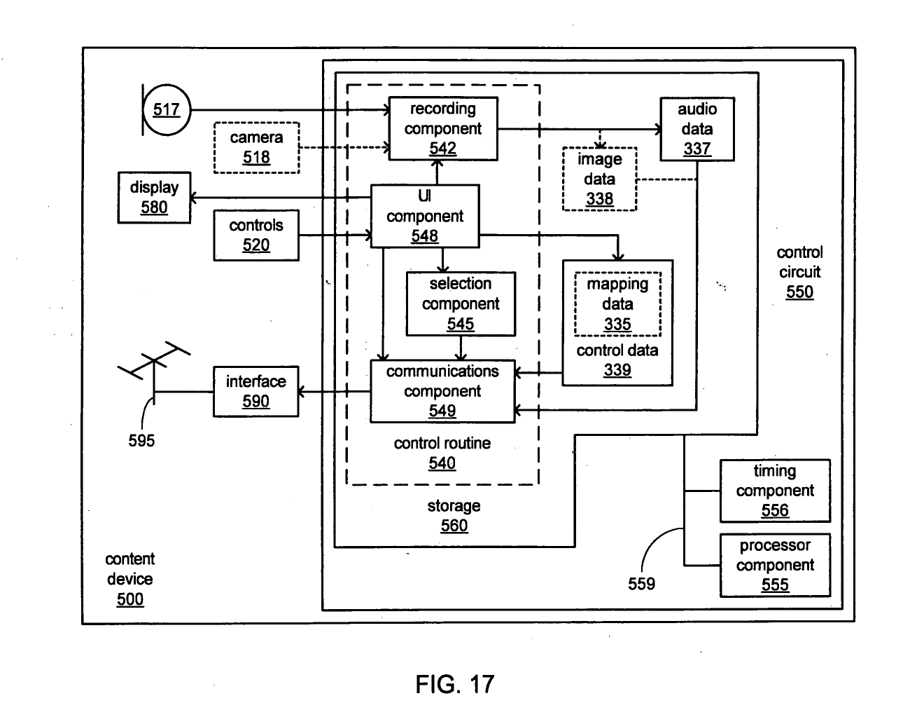

FIG. 16 illustrates an embodiment of a processing architecture suitable for implementing the control circuit 350 of any of the embodiments of the interaction device 300 depicted in FIG. 2, 6, 8, 10, 13 or 15. As depicted, the control circuit 350 incorporates one or more of a processor component 355 a timing component 356, a storage 360 and a coupling 359. Correspondingly, FIG. 17 illustrates an embodiment of a processing architecture suitable for implementing the control circuit 550 of any of the embodiments of the control device 300 depicted in FIG. 8, 10, 13 or 15. As depicted, the control circuit 550 incorporates one or more of a processor component 555 a timing component 556, a storage 560 and a coupling 559.

Referring to FIGS. 16 and 17, each of the couplings 359 and 559 may include one or more buses, point-to-point interconnects, transceivers, buffers, crosspoint switches, and/or other conductors and/or logic that communicatively couples at least the processor components 355 and 555 to the storages 360 and 560, respectively. The couplings 359 and 559 may each further couple the processor components 355 and 555 to one or more other components, such as the timing components 356 and 556, respectively. With the processor components 355 and 555 being so coupled by the couplings 359 and 559, the processor components 355 and 555 are able to perform the various ones of the tasks described above as performed by the control circuits 350 and 550, respectively.

The couplings 359 and 559 may each be implemented with any of a variety of technologies or combinations of technologies by which signals are optically and/or electrically conveyed. The processor components 355 and 555 may each include any of a wide variety of commercially available processors, employing any of a wide variety of technologies and implemented with one or more cores physically combined in any of a number of ways.

The storages 360 and 560 may each be made up of one or more distinct storage devices based on any of a wide variety of technologies or combinations of technologies. More specifically, the storages 360 and 560 may include one or more of volatile storage (e.g., solid state storage based on one or more forms of RAM technology), non-volatile storage (e.g., solid state, ferromagnetic or other storage not requiring a constant provision of electric power to preserve their contents), or removable media storage (e.g., removable disc or solid state memory card storage by which information may be conveyed between computing devices).

The storages 360 and 560 may each include an article of manufacture in the form of a non-transitory machine-readable storage media on which a routine including a sequence of instructions executable by the processor component 355 and 555, respectively, may be stored, depending on the technologies on which each is based. Thus, a routine including a sequence of instructions to be executed by the processor component 355 or 555 may initially be stored on a non-transitory machine-readable storage medium of the storage 360 or 560, respectively. That routine may then be copied from that medium to a volatile portion of the storage 360 or 560 to enable more rapid access by the processor component 355 or 555, respectively, as that routine is executed.

As depicted in FIG. 16, stored within the storage 360 is a control routine 340 made up of a sequence of instructions that when executed by the processor component 355 cause the processor component 355 to at least monitor the sensor(s) 310, 310a and/or 310b for an indication of physical handling of the pillow portion 100, and to operate the acoustic driver 370 to acoustically output an audio recording in response to the physical handling. The storage 360 may additionally store audio data 337 representing one or more audio recordings stored in digital form, image data 338 representing one or more still images stored in digital form, and/or control data 339 including indications of one or more parameters specifying aspects of monitoring for and responding to indications of physical handling of the pillow portion 100. As depicted in FIG. 17, stored within the storage 560 is a control routine 540 made up of a sequence of instructions that when executed by the processor component 555 cause the processor component 555 to at least monitor the controls 520 for an indication of manual operation thereof, and to operate the interface 590 to transmit an audio recording and/or an image 880 to the interaction device 300. The storage 560 may additionally store the audio data 337, the image data 338 and/or the control data 339.

Referring to FIGS. 16 and 17, the control routines 340 and 540 may include a communications component 349 and 549 executable by the processor components 355 and 555 to operate the interfaces 390 and 590, respectively, to transmit and receive signals therebetween via one or more networks as has been described. Among the signals exchanged may be signals conveying images 880 to be visually presented and/or audio recordings to be acoustically output in response to detection of physical handling of the pillow portion. As recognizable to those skilled in the art, each of these communications components are selected to be operable with whatever type of interface technology is selected to implement corresponding ones of the interfaces 390 and 590.

The control routines 340 and 540 may include a recording component 342 and 542 executable by the processor components 355 and 555 to operate the microphones 317 and 517, respectively, to record at least one audio recording stored as part of the audio data 337. Such operation of the microphone 317 or of the microphone 517 may be in response to receipt of an indication of manual operation of the controls 320 or 520, respectively, to convey a command to record an audio recording. Where an audio recording is recorded by the processor component 555 via the microphone 517, the processor components 355 and 555 may additionally be caused, via execution of the communications components 349 and 549, respectively, to cooperate to convey at least a portion of the audio data 337 representing the audio recording from the content device 500 to the interaction device 300. Further, where images 880 are also conveyed to the interaction device 300 from the content device 500, the recording component 542 may additionally operate a camera 518 to record images 880 and store images 880 as part of the image data 338 prior to being so conveyed.

Turning more specifically to FIG. 16, the control routine 340 may include a monitoring component 341 for execution by the processor component 355 to monitor at least the sensor(s) 310, 310a and/or 310b for an indication of physical handling of the pillow portion 100 that serves as a trigger to cause the acoustic output of an audio recording. As has been discussed, there may be only specific types of physical handling that are to serve as such a trigger, such as squeezing, bending, poking, etc. of a particular portion of the pillow portion 100 at which an image is visually presented (e.g., at a portion of the outer surface 111 at which the image 888 is visually presented). Thus, the monitoring component 341 may accept one or more selected types of physical handling as a trigger, but ignore other types (e.g., may accept a push against a portion of the outer surface 111 at which an image is visually presented, but ignore a push against any part of the outer surface 112). As also discussed, a particular type of physical handling that the monitoring component 341 may accept as a trigger may be required to occur throughout at least a selected minimum period of time before the monitoring component 341 accepts that particular type of physical handling as a trigger.

As has also been discussed, in embodiments in which more than one selected type of physical handling is accepted as a trigger, different audio recordings may be selected based on which type of the more than one selected types of physical handling is detected. By way of example, where physical handling is directed at one of two images (e.g., directed at an image 880a, rather than directed at an image 880b), an audio recording associated with a person, place or object depicted in that one image may be selected to be acoustically output, rather than an audio recording associated with a person, place or object depicted in the other image. Thus, the selection of which of more than one audio recording to acoustically output may be determined by a selection made by a patient of which portion of the pillow portion 100 at which to direct physical handling. In such embodiments, the monitoring component 341 may monitor multiple sensors (e.g., the combination of the sensors 310a and 310b) that are separately positioned within the pillow portion 100 to enable detection of physical handling directed at one portion of the pillow portion 100 (at which one image may be visually presented) rather than at another portion of the pillow portion 100 (at which another image may be visually presented).

Alternatively or additionally, the monitoring component 341 may operate the interface 390 to monitor for wireless transmissions of identifiers and/or indications of physical handling from tag devices (e.g., one or more of the tag devices 185, 185a and/or 185b) as part of detecting physical handling of one portion or another of the pillow portion 100. Such tag devices may be used to provide an indication of what images are currently presented by indicating which photograph is currently inserted into a pouch and/or which pillow case 110 currently surrounds the cushion portion 150. Such tag devices may also incorporate sensors able to detect physical handling directed at the photograph or portion of the pillow case 110 into which they are incorporated. As has been discussed, the ability to identify what image(s) are currently displayed and/or towards what image is physical handling currently directed at may be utilized to select an audio recording from among multiple audio recordings.

The control data 339 may include an indication of what type(s) of physical handling are to be accepted as a trigger to acoustically output an audio recording. The control data 339 may also include an indication of the minimum period of time for which one or more selected types of physical handling must be continuously detected as occurring to be accepted as such a trigger. The monitoring component 341 may retrieve such indications from the control data 339.

The control routine 340 may include an output component 347 for execution by the processor component 355 to operate the acoustic driver 370 to acoustically output an audio recording stored as at least a portion of the audio data 337. The output component 347 may be triggered to so operate the acoustic driver 370 in response to an indication from the monitoring component 341 indicating that a sensor (e.g., the sensor 310, 310a or 310b) has detected a type of physical handling of the pillow portion 100 that is accepted as a trigger for the acoustic output of an audio recording.

As previously discussed, the audio data 337 may represent multiple audio recordings in digital form. As depicted, the output component 347 may incorporate a selection component 345 to select one of multiple audio recordings stored as part of the audio data 337 based on one or more factors. In some embodiments, one of the factors may be which type of physical handling has been detected out of what may be multiple types of physical handling selected to be accepted as a trigger to acoustically output an audio recording. More specifically, the selection component 345 may be provided with an indication from the monitoring component 341 of which type of physical handling has been detected, and may select an audio recording to acoustically output based on that indication.

In other embodiments, one of the factors utilized to select an audio recording may be one or more of the current time of day, the current day of a week and/or the current date of a year. More specifically, the selection component 345 may be provided with an indication from the timing component 356 of what is the current time and/or current date, and the selection component 345 may select an audio recording based on that indication. For example, the selection component 345 may select an audio recording including a voice saying “good night” or similar words during nighttime hours in lieu of another audio recording to be acoustically output during daytime hours. By way of another example, upon the approach of a particular date on a calendar on which a particular holiday occurs, the selection component 345 may select an audio recording associated with that particular holiday in lieu of another audio recording to be acoustically output during other dates of a year.

In still other embodiments, one of the factors utilized to select an audio recording may be indications provided by tag devices and/or other possible mechanisms of what images are currently visually presented by the pillow portion 100. More specifically, the selection component 345 may be provided with an indication of an identifier associated with a particular image that is currently visually presented out of multiple possible images that could, at other times, be visually presented. For example, an identifier may be provided to the selection component 345 that an image of a beach scene is currently visually presented instead of an image of a grandchild of a patient who has been provided with the patient comfort pillow 200. The selection component 345 may utilize that identifier to select an audio recording of environmental sounds of waves at that beach to be acoustically output in lieu of another audio recording of that grandchild singing.

In yet other embodiments, audio recordings for acoustic output may be randomly selected where the audio data 337 includes more than one audio recording that is associated with an image 880 currently visually presented. More specifically, to avoid excessive repetition of a single audio recording associated with a person, object or place depicted in the image 880, one of multiple audio recordings so associated may be randomly selected each time there is triggering of acoustic output of an audio recording. Alternatively or additionally, where instances of physical handling that trigger acoustic output occur with greater frequency and/or where a duration of an instance of such physical handling is longer, then the selection component 345 may select multiple audio recordings associated with a person, object or place depicted in the image 880 to acoustically output together, one after another, to cause acoustic output to occur over a longer period of time.

As depicted, the control data 339 may include mapping data 335 that provides an indication of which audio recordings of multiple audio recordings represented by the audio data 337 are to be selected for acoustic output based on one or more factors. For example, the mapping data 335 may indicate which audio recording to select depending on a current hour of a day, current day of a week, current date of a year, or the like. Alternatively or additionally, the mapping data 335 may indicate which audio recording to select depending on type of physical handling is detected. Also alternatively or additionally, the mapping data 335 may indicate which audio recording to select depending on an identifier associated with an image to which physical activity is directed.

In embodiments in which the pillow portion incorporates the display 380, the control routine 340 may include a presentation component 348 for execution by the processor component 355 to operate the display 380 to visually present one or more images 880 stored as at least part of the image data 338 in digital form. In some embodiments, the presentation component 348 may change what image is visually presented on the display 380 at either a regular interval of time or at random intervals of time. The presentation component 348 may receive indications from the monitoring component 341 of selected type(s) of physical handling of the pillow portion 100 that convey a command to change an currently visually presented image relatively immediately, rather than await the end of a current interval of time before doing so. Alternatively or additionally, the presentation component 348 may receive indications of selected type(s) of physical handling that convey a command to refrain from changing the currently visually presented image. Also alternatively or additionally, the presentation component 348 may receive indications of an orientation of the pillow portion 100 (and therefore, of the display 380) relative to the direction of the force of gravity, and may rotate the orientation with which the one or more images 880 are visually presented on the display 380 to keep the one or more images 880 generally “right side up” on the display 380.

Further, indications of what image is currently visually presented by the presentation component 348 may be provided to the selection component 345, and those indications may be utilized by the selection component 345 as a factor to select an audio recording for acoustic output. More specifically, indications of what image is currently visually presented may be utilized to select an audio recording that is associated with that currently visually presented image.

Turning more specifically to FIG. 17, the control routine 540 may include a user interface (UI) component 542 for execution by the processor component 550 to monitor the controls 520 and operate the display 580 to provide a UI to an operator of the content device 500. Such a UI may be utilized to provide a user friendly mechanism by which the operator may remotely control aspects of the operation of the interaction device 300. More specifically, the UI component 548 may store, as part of the control data 339, indications of selections of various operating parameters of the interaction device 300 made by the operator of the content device 500. Upon the selection and storage of one or more of such parameters, the processor components 355 and 555 may cooperate, via their execution of the communications routines 349 and 549, respectively, to transmit the control data 339 from the content device 500 to the interaction device 300 via one or more networks extending therebetween.

As previously discussed, the parameter selections so indicated in the control data 339 may specify what type(s) of physical handling are selected to be accepted as a trigger to acoustically output an audio recording and/or for what minimum period of time the selected type(s) of physical handling must be continuously detected to be accepted as such a trigger. The UI provided by the UI component 548 may visually present a menu of choices of such parameters on the display 580 and may monitor the controls 520 for indications of manual operation thereof to make selections from among what is visually presented in the menu.

The control routine 540 may include a selection component 545 for execution by the processor component 555 to automatically select an audio recording to be acoustically output by the interaction device 300. More specifically, the selection component 545 may receive indications from the timing component 556 of a time of day, a day of a week and/or a date of a year, and may utilize those indications to select an audio recording to be acoustically output in lieu of another audio recording based on the arrival of a particular time, day of a week and/or date of a year. The selection component 545 may cooperate with the communications component 549 to transmit an indication to the interaction device 300 to acoustically output that selected audio recording in lieu of another audio recording. In some embodiments, such a transmitted indication may include at least a portion of the control data 339 in which there is a change to the mapping data 335 to indicate that the selected audio recording is to be acoustically output. In other embodiments, such a transmitted indication may include at least a portion of the audio data 337 representing the selected audio recording in digital form.

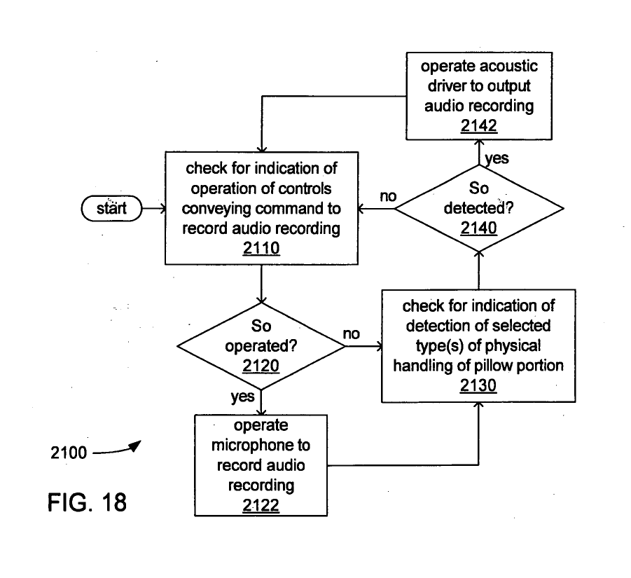

FIG. 18 illustrates a flowchart of logic that may be implemented in one or more embodiments described herein. More specifically, the flowchart 2100 may illustrate operations performed by the processor component 355 in executing at least a portion of the control routine 340, and/or performed by other component(s) of the interaction device 300.

At 2110, a check is made for an indication of manual operation of controls of an interaction device of a patient comfort pillow (e.g., the controls 320 of the interaction device 300 of the patient comfort pillow 200) to convey a command to record an audio recording.

If, at 2120, there is no indication of the controls being so operated, then a check is made at 2130 for an indication of selected type(s) of physical handing of a pillow portion of the patient comfort pillow (e.g., the pillow portion 100) having been detected. However, if there is such an indication at 2120, then a microphone of the interaction device is operated at 2122 to record an audio recording before the check at 2130 is made.

If, at 2140, there is no indication of the selected type(s) of physical handling having been detected, then the check for an indication of manual operation of the controls is repeated at 2110. However, if there is such an indication at 2140, then an acoustic driver of the interaction device (e.g., the acoustic driver 370) is operated at 2142 to acoustically output the audio recording before the check at 2110 is repeated.

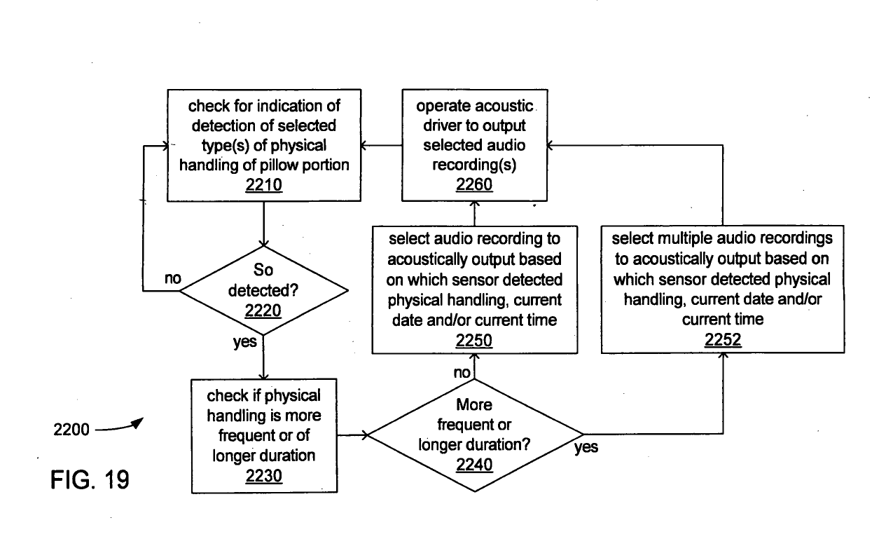

FIG. 19 illustrates a flowchart of logic that may be implemented in one or more embodiments described herein. More specifically, the flowchart 2200 may illustrate operations performed by the processor component 355 in executing at least a portion of the control routine 340, and/or performed by other component(s) of the interaction device 300.

At 2210, a check is made for an indication of selected type(s) of physical handing of a pillow portion of the patient comfort pillow (e.g., the pillow portion 100 of the patient comfort pillow 200) having been detected. If, at 2220, there is no indication of the selected type(s) of physical handling having been detected, then the check for that indication is repeated at 2210. However, if there is an indication of the selected type(s) of physical handling having been detected at 2220, then a check is made at 2230 as to whether there are more frequent instances of the selected type(s) of physical handling occurring or if a current instance of the selected type(s) of physical handling is of a longer duration.

If, at 2240, the current instance of physical handling is not part of more frequently occurring instances or is not of longer duration, then an audio recording to be acoustically output is selected at 2250 based on one or more factors, which may include one or more of which sensor detected the physical handling, what the current time is and/or what the current date is. However, if the current instance of physical handling is part of more frequently occurring instances or is of longer duration, then multiple audio recordings to be acoustically output are selected at 2252 based on such one or more factors.

At 2260, an acoustic driver of an interaction device of the patient comfort pillow (e.g., the acoustic driver 370 of the interaction device 300) is operated to acoustically output the selected audio recording.

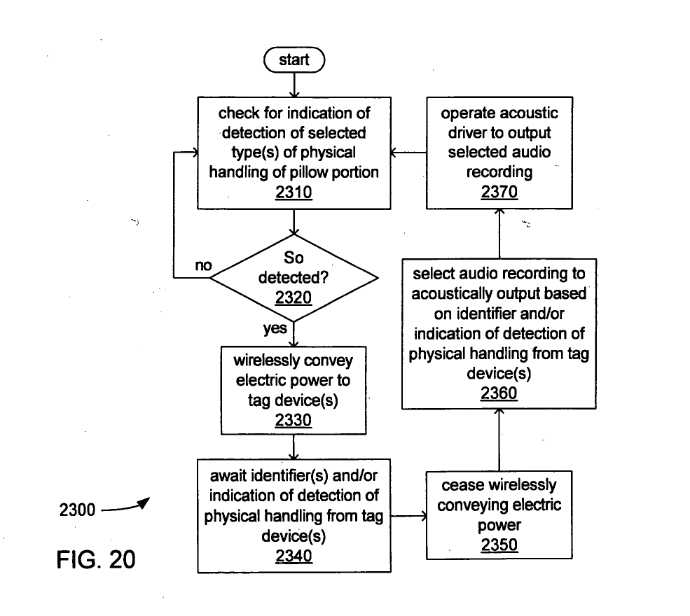

FIG. 20 illustrates a flowchart of logic that may be implemented in one or more embodiments described herein. More specifically, the flowchart 2300 may illustrate operations performed by the processor component 355 in executing at least a portion of the control routine 340, and/or performed by other component(s) of the interaction device 300.

At 2310, a check is made for an indication of selected type(s) of physical handing of a pillow portion of the patient comfort pillow (e.g., the pillow portion 100 of the patient comfort pillow 200) having been detected. If, at 2320, there is no indication of the selected type(s) of physical handling having been detected, then the check for that indication is repeated at 2310.

However, if there is an indication of the selected type(s) of physical handling having been detected at 2220, then electric power is wirelessly provided to one or more tag devices (e.g., one or more of the tag devices 185, 185a and/or 185b). At 2340, receipt of wirelessly transmitted identifier(s) and/or of an indication of physical handling directed at an image or portion of an image co-located with a tag device is awaited. Following receipt of identifier(s) and/or such an indication, the wireless provision of electric power ceases at 2350.

At 2360, an audio recording to be acoustically output is selected at 2230 based on one or more factors, which may include one or more of an identifier wirelessly received at 2340 and/or an indication wirelessly received at 2340 of physical handling directed at an image or a portion of an image co-located with a tag device. At 2370, an acoustic driver of an interaction device of the patient comfort pillow (e.g., the acoustic driver 370 of the interaction device 300) is operated to acoustically output the selected audio recording.

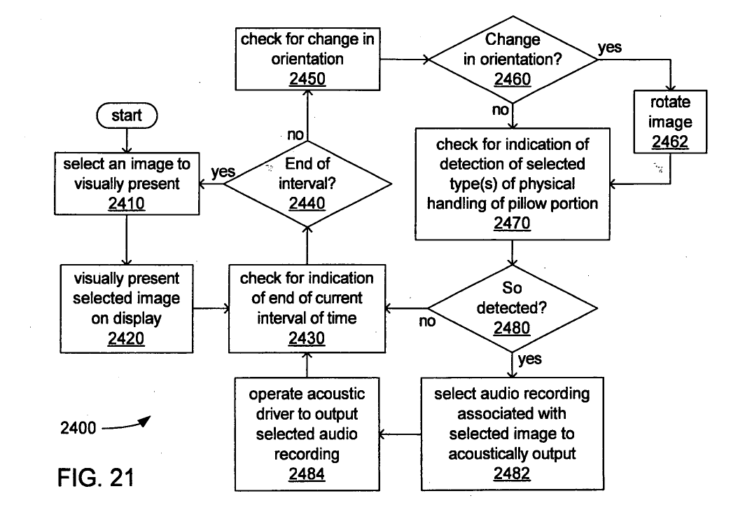

FIG. 21 illustrates a flowchart of logic that may be implemented in one or more embodiments described herein. More specifically, the flowchart 2400 may illustrate operations performed by the processor component 355 in executing at least a portion of the control routine 340, and/or performed by other component(s) of the interaction device 300.

At 2410, an image is selected to be visually presented on a display of a patient comfort pillow (e.g., the display 380 of the patient comfort pillow 200). At 2420, the display is operated to display the selected image for an interval of time. At 2430, a check is made as to whether the interval of time has yet ended. If, at 2440, the interval of time has ended, then another image is selected to be visually presented on the display at 2410.

However, if there the interval has not ended at 2440, then a check is made at 2450 an indication of change in orientation of a portion of the patient comfort pillow into which the display is incorporated (e.g., the pillow portion 100) such that the orientation of the display has changed relative to the direction of the force of gravity. If, at 2460, such a change in orientation has occurred, then the display is operated at 2462 to rotate the image, as it is visually presented on the display, to cause the image to be visually presented with its top edge oriented generally upward.

At 2470, a check is made for an indication of selected type(s) of physical handing of a pillow portion of the patient comfort pillow (e.g., the pillow portion 100) having been detected. If, at 2480, there is no indication of the selected type(s) of physical handling having been detected, then the check for whether the interval of time has ended is repeated at 2430.

However, if there is an indication of the selected type(s) of physical handling having been detected at 2480, then an audio recording to be acoustically output is selected at 2482 based on an association of the audio recording with the currently visually presented image. At 2484, an acoustic driver of an interaction device of the patient comfort pillow (e.g., the acoustic driver 370 of the interaction device 300) is operated to acoustically output the selected audio recording before the check at 2430 is repeated.

Although the invention has been described in a preferred form with particularity, it is understood that the present disclosure of the preferred form has been made only by way of example, and that numerous changes in the details of construction and the combination and arrangement of parts may be resorted to without departing from the spirit and scope of the invention.

1. A patient comfort pillow having an outer surface that carries an image that is meaningful to a patient, and having an interior space carrying an acoustic driver that acoustically outputs an audio recording associated with the image and to which the patient can listen in response to physical handling directed at the image by the patient.

2. The patient comfort pillow of claim 1, comprising a pouch on the outer surface to hold a photograph bearing the image, the pouch comprising a transparent material to enable the image to be viewed with the photograph inserted into the pouch.

3. The patient comfort pillow of claim 1, wherein the image is printed on or sewn into the outer surface.

4. The patient comfort pillow of claim 1, comprising a microphone carried within the interior space to record the audio recording.

5. The patient comfort pillow of claim 1, comprising an antenna to wirelessly receive at least one of the audio recording or the image.

6. An apparatus comprising:
a pillow portion defining an outer surface to visually present an image and comprising a cushion portion shaped to define an, interior space of the pillow portion surrounded by soft material; and
an interaction device for insertion into the interior space, the interaction device comprising an acoustic driver, and a control circuit to monitor a first sensor for an indication of detection by the first sensor of a selected type of physical handling of the pillow portion and to operate the acoustic driver to acoustically output an audio recording associated with the image based on the indication of detection.

7. The apparatus of claim 6, the pillow portion comprising a pouch on the outer surface to hold a photograph bearing the image to visually present the image on the outer surface.

8. The apparatus of claim 7, the photograph comprising a tag device to wirelessly transmit an identifier associated with the photograph to the interaction device, the interaction device to utilize the identifier to select the audio recording.

9. The apparatus of claim 6, the pillow portion directly bearing the image on the outer surface.

10. The apparatus of claim 9, the image printed onto the outer surface.

11. The apparatus of claim 6, the interaction device comprising a manually operable control and a microphone, the control circuit to monitor the manually operable control for an indication of manual operation thereof to convey a command to record the audio recording and to operate the microphone to record the audio recording in response to the command.

12. The apparatus of claim 6, the interaction device comprising an interface and an antenna, the control circuit to operate the interface to wirelessly receive at least one of the audio recording, the image or, an indication of a parameter of operation of detecting the selected type of physical interaction from another device via the interface and the antenna.

13. The apparatus of claim 6, comprising the first sensor and a second sensor, wherein:
the first sensor is co-located with the image;
the second sensor is co-located with another image; and
the control circuit monitors the second sensor for an indication of detection by the second sensor of the selected type of physical handling of the pillow portion and selects the audio recording to correspond with one of the image and the other image based on which of the first and second sensors detects the selected type of physical handling.

14. The apparatus of claim 6, the control circuit comprising:
a processor component;
a timing component coupled to the processor component to maintain at least one of a current time or a current date; and
a selection component for execution by the processor component to select the audio recording based on the at least one of the current time or the current date indicated to the processor component by the timing component.

15. The apparatus of claim 6, comprising an interface and an antenna, wherein the control circuit comprises:
a processor component;
a monitoring component for execution by the processor component to:
operate the interface and antenna to generate an electromagnetic field to wirelessly provide electric power to at least one tag device in response to the indication of detection; and
operate the interface to wirelessly receive at least one identifier from the at least one tag device; and
a selection component for execution by the processor component to select the audio recording based at least partly on the at least one identifier.

16. The apparatus of claim 15, wherein:
the at least one tag device comprises a first tag device co-located with the image and a second tag device co-located with another image;
the monitoring component operates the interface to wirelessly receive an indication of whether the selected physical handling is directed at the first tag device or the second tag device; and
the selection component selects the audio recording based at least partly on the wirelessly received indication.

17. The apparatus of claim 6, comprising a display, wherein the control circuit comprises:
a processor component;
a presentation component for execution by the processor component to operate the display to visually present the image, to change the image visually presented on the display at an interval, and to rotate the orientation of the image on the display based on a direction of a force of gravity; and
a selection component for execution by the processor component to select the audio recording based on an association of the audio recording to the image currently visually presented on the display.

18. A computer-implemented method comprising:
visually presenting an image on an outer surface of a pillow portion of a patient comfort pillow comprising the pillow portion and an interaction device, wherein the pillow portion defines an interior space in which the interaction device is carried and is substantially surrounded by soft material of a cushion portion of the pillow portion;
monitoring a first sensor of the patient comfort pillow for an indication of detection by the first sensor of a selected type of physical handling of the pillow portion; and
operating an acoustic driver of the interaction device to acoustically output an audio recording associated with the image based on the indication of detection.

19. The computer-implemented method of claim 18, comprising refraining from operating the acoustic driver to acoustically output the audio recording until the selected type of physical handling has been detected as occurring for at least a selected minimum period of time.

20. The computer-implemented method of claim 18, the selected type of physical handling comprising at least one of squeezing of the pillow portion, bending of the pillow portion, folding of the pillow portion, shaking of the pillow portion or pressing against the image.

21. The computer-implemented method of claim 18, comprising:
monitoring a manually operable control of the interaction device for an indication of manual operation thereof to convey a command to record the audio recording; and
operating a microphone of the interaction device to record the audio recording in response to the command.

22. The computer-implemented method of claim 18, comprising operating an interface of the interaction device to wirelessly receive at least one of the audio recording, the image, or an indication of a parameter of operation of detecting the selected type of physical interaction from another device via the interface and an antenna of the interaction device.

23. The computer-implemented method of claim 22, the indication of a parameter comprising at least one of an indication of the selected type of physical handling or a minimum period of time during which the selected type of physical handling must occur to trigger operation of the acoustic driver to acoustically output the audio recording.

24. The computer-implemented method of claim 18, comprising: monitoring a second sensor of the patient comfort pillow for an indication of detection by the second sensor of the selected type of physical handling of the pillow portion, wherein the first sensor is co-located with the image and the second sensor is co-located with another image; and
selecting the audio recording to correspond with one of the image and the other image based on which of the first and second sensors detects the selected type of physical handling.

25. The computer-implemented method of claim 18, comprising selecting the audio recording based on the at least one of a current time, a current day of a week, a current date or a currently occurring holiday.

26. The computer-implemented method of claim 18, comprising:
operating an interface and an antenna of the interaction device to generate an electromagnetic field to wirelessly provide electric power to at least one tag device in response to the indication of detection;
operating the interface to wirelessly receive at least one identifier from the at least one tag device; and
selecting the audio recording based at least partly on the at least one identifier.

27. The computer-implemented method of claim 26, wherein:
the at least one tag device comprises a first tag device co-located with the image and a second tag device co-located with another image; and
the computer-implemented method comprises:
operating the interface to wirelessly receive an indication of whether the selected physical handling is directed at the first tag device or the second tag device; and
selecting the audio recording based at least partly on the wirelessly received indication.

28. The computer-implemented method of claim 18, comprising:
selecting multiple audio recordings to acoustically output based on at least one of a frequency with which the selected type of physical handling occur or a duration of an occurrence of the selected type of physical handling, the multiple audio recordings comprising the audio recording; and
operating the acoustic driver to acoustically output the multiple audio recordings.

29. The computer-implemented method of claim 18, comprising:
operating a display to visually present the image;
changing the image visually presented on the display at an interval; and
selecting the audio recording based on an association of the audio recording to the image currently visually presented on the display.

30. At least one non-transitory machine-readable storage medium comprising instructions that when executed by, a processor component, cause the processor component to:
operate a display of a patient comfort pillow to visually presenting an image, wherein the pillow portion defines an interior space in which an interaction device of the patient comfort pillow is carried and is substantially surrounded by soft material of a cushion portion of the pillow portion, and wherein the interaction device comprises the processor component;
monitor a first sensor of the patient comfort pillow for an indication of detection by the first sensor of a selected type of physical handling of the pillow portion;
select the audio recording based at least partly on an association of the audio recording to the image currently visually presented on the display; and
operate an acoustic driver of the interaction device to acoustically output the audio recording associated with the image based on the indication of detection.

31. The at least one non-transitory machine-readable storage medium of claim 30, the processor component caused to refrain from operating the acoustic driver to acoustically output the audio recording until the selected type of physical handling has been detected as occurring for at least a selected minimum period of time.

32. The at least one non-transitory machine-readable storage medium of claim 30, the processor component caused to:
monitor a manually operable control of the interaction device for an indication of manual operation thereof to convey a command to record the audio recording; and
operate a microphone of the interaction device to record the audio recording in response to the command.

33. The at least one non-transitory machine-readable storage medium of claim 30, the processor component caused to operate an interface of the interaction device to wirelessly receive at least one of the audio recording, the image or an indication of a parameter of operation of detecting the selected type of physical interaction from another device via the interface and an antenna of the interaction device.

34. The at least one non-transitory machine-readable storage medium of claim 30, the processor component caused to select the audio recording at least partly based on the at least one of a current time, a current day of a week, a current date or a currently occurring holiday.
